(19) United States
(12) Patent Application Publication
(10) Pub. No.: US 2018/0060932 A1
(43) Pub. Date: Mar. 1, 2018

(54) DATA ACQUISITION ENHANCEMENT USING SINGLE-DESTINATION MANAGEMENT

(71) Applicant: KLEKOS, LLC, Hollywood, FL (US)

(72) Inventors: Randi Lee Kleckler, Hollywood, FL (US); Jeffrey Scott Kostick, Plantation, FL (US)

(21) Appl. No.: 15/690,220

(22) Filed: Aug. 29, 2017

Related U.S. Application Data
(60) Provisional application No. 62/380,548, filed on Aug. 29, 2016.

(51) Int. Cl. G06Q 30/06; G06Q 30/02; G06Q 30/00; G06Q 50/00

(52) U.S. Cl. CPC G06Q 30/0613; G06Q 30/0633; G06Q 30/0639; G06Q 50/01; G06Q 30/0277; G06Q 30/01; G06Q 30/0643

(57) ABSTRACT

Enhancing data acquisition over multiple on-line platforms is described. The technical difficulties with multiple platforms offering or advertising a branded item are addressed by generating a shoppable address that can be associated with a content related to the branded item any number of websites, such as an image or video file advertising or describing the branded item. The shoppable address is a hyperlink that, when clicked on by a consumer, presents the consumer with a unique, single destination—a webpage scripted to include purchase information for the branded item from multiple retail sources, with links to the multiple retail sources. The links may be hyperlinks directly to the branded item at an on-line retail source, or may be contact information for a brick-and-mortar retail source of the branded item within a geographic area defined by the consumer.

### CROSS-REFERENCE TO RELATED APPLICATION

This application claims priority to U.S. Provisional Patent Application No. 62/380,548, filed Aug. 29, 2016, the content of which is incorporated herein in its entirety by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The disclosure relates in general to enhancing data acquisition using single-destination management, and more particularly using a single webpage destination accessible through multiple platforms to enhance data acquisition.

### BACKGROUND

Originators of products or services may offer those products or services on their own website, and also may advertise and/or offer products or services for sale on websites operated by third parties, for example, on-line retailers. Websites of retailers are not the exclusive platform through which an originator supplies advertising content. An originator may also use various social media to reach out to purchasers through the use of posts, paid or otherwise. Each of these platforms provides a different path for acquisition of a product or service.

Often in advertising using an on-line retailer, one or more products or services are bundled on a single webpage that may originate from the same or different originators. For example, on a travel website, the user may be offered the opportunity to purchase hotel, rental cars and flights offered from different companies from a single webpage.

### BRIEF SUMMARY

Methods, apparatuses, and systems for enhancing data acquisition within a computing network are described. An implementation of a method described herein includes determining an image file or a video file for a post related to a first branded item, determining a title for the post, determining multiple retail sources for purchasing the first branded item, determining a shoppable address within the computing network using the title, and generating, responsive to selection of the shoppable address included in association with content related to the branded item within a webpage, the post in the form of a scripted webpage of a website operated by a first computing device that performs the method, the scripted webpage including a respective link to retail sources of the multiple retail sources.

An implementation of a system described herein includes a non-transitory storage medium, and a processor of a first computing device configured to execute instructions stored within the non-transitory storage medium to perform the above method:

Details of these implementations, variations in these implementations, and additional implementations are discussed in the following description, claims, and drawings.

### BRIEF DESCRIPTION OF THE DRAWINGS

In the drawings, like numbers indicate like parts throughout the views unless otherwise noted.

FIG. 1 is a block diagram showing a network environment in which the teachings herein may be implemented.

FIG. 2 is a block diagram showing an example of a hardware configuration for a computing device that may be used to implement the teachings herein.

FIG. 3 is a flowchart diagram of a method for enhancing data acquisition over multiple platforms within a computing network according to the teachings herein.

FIGS. 4A and 4B are screenshots depicting a dashboard for a brand.

FIGS. 5A and 5B are screenshots depicting settings for a brand.

FIGS. 6A-6E are screenshots depicting creation of a post for a brand.

FIG. 7 is a screenshot depicting a gallery of images or videos that may be used in the creation of a post for a brand.

FIG. 8 is a screenshot depicting the management of retailers for a brand.

FIGS. 9A and 9B are screenshots depicting the management of influencers and digital ads for a brand.

FIGS. 10A and 10B are screenshots depicting editing of a post for a brand.

FIGS. 11A-11D are screenshots depicting a post at a shoppable address.

FIG. 12 is a screenshot depicting a want list for a registered consumer.

FIGS. 13A-13E are screenshots depicting a first implementation of post reports and analytics.

FIGS. 14A-14D are screenshots depicting a second implementation of post reports and analytics.

FIGS. 15A-15E are screenshots depicting a third implementation of post reports and analytics.

### DETAILED DESCRIPTION

An originator of a product or service faces a number of difficulties in completing a purchase with a consumer that are imposed by an on-line environment. As used herein, the product or service may be referred to as a branded item, to reflect that the product or service being referred to is a type of product or service that is manufactured or performed by a specific source or originator under a specific name, sign, symbol(s), design, and/or words, such as a trade name, a trademark, a service mark, a proprietary name, a label, a make, etc., regardless of whether the product or service is being advertised or offered by the particular originator or a third-party source, such as a retailers, etc., that may advertise or offer the branded items. Through such means, the branded items are distinguished from products and services that are offered by originators other than the specific originator. As used herein, the originator of branded item(s) may be referred to as a brand to distinguish the originator from the third-party sources.

Research has shown that on-line consumers are less likely to purchase from the website of a brand than from the website of a well-known retailer selling the branded items. This makes the availability of branded items on multiple platforms desirable. However, technical limitations of the platforms can impose problems in the relationship between the brand and consumers. These technical limitations reduce the amount of data available to each of the brand and the consumer to make decisions.

One technical limitation is that many platforms either expressly or inherently limit linking to only one retail destination (e.g., to the brand website or an on-line retailer). This is particularly, although not exclusively, a problem with posts on digital platforms (e.g., blogs, webpages, ads, etc.) or social media platforms. For example, the social media platform referred to as Pinterest expressly allows only one external link per post. As another example, the social media platform Twitter, by limiting the number of characters in a post, inherently limits external links. The social media platform referred to as Instagram does not allow linking to external destinations from individual posts, and only allows one external link in a profile. Even without these limitations, multiple links to different destinations would clutter and potentially confuse a consumer. For a brand, linking to its own website or to a single retailer can reduce the effectiveness of a post, such as an advertisement, because the consumer may be unwilling to purchase from the brand website or the particular retailer.

An on-line retailer as a platform for advertising or offering a brand presents a similar technical limitation, among others. Namely, an on-line retailer has no incentive to link to any retailer other than itself. An on-line retailer often presents several different products or services from the same or different brands on a single webpage. Along with this, the user is often offered suggestions of other items that purchasers also purchased from the same on-line retailer. To review and/or purchase all of the suggested items, the user must access a different webpage of the on-line retailer for an item and often must return to the original webpage to find the other items. Sometimes it can be difficult to navigate back to the original webpage, and the brand may miss out on making additional sales from those webpages, or any sales at all from the original webpage. This also can result in difficulty for a consumer seeking to make one or more purchases.

As seen from this description, a further problem with the use of multiple platforms is that each platform has its own platform-specific approach to content that may require a brand to modify its dissemination of advertising or offers.

Another technical limitation imposed by a platform on a brand is how long the content will be relevant and searchable. On-line retailers continuously receive new items, for example, and may move older content from the brand to lower in search results. Social media platforms may cut-off results from a search to a certain number of items, reducing the visibility of the content related to the brand as that content ages. On the other hand, the brand may itself wish to reduce the relevance of a particular product or service in searches, particularly where a new release is made.

Other technical limitations are shared, at least to some extent, between platforms that reduce the connection of a consumer with a brand. For example, on-line content does not, in general, effectively drive consumers to brick and mortar retailers of the brand. This may reduce sales to consumers unable or unwilling to purchase branded items on-line. Further, the brand is often limited in the consumer data it receives based on the platform. Impressions or “clicks” may be tallied and provided with aggregated data, for example. In some social media platforms, certain public information may be shared. There is little personally-identifiable information (PII) of consumers available to the brand from third-party social, digital, and/or influencer content. Moreover, the brand is unable to evaluate the performance of a channel (e.g., a website or webpage operated by a website), influencer, and/or a particular advertisement using, e.g., key performance indicators.

Implementations of the teachings herein address these technical limitations and others by enhancing the content in a post related to a branded item (e.g., an advertisement) to make the content shoppable, i.e., to provide a consumer, sometimes called a user herein, with a shoppable address to a single webpage destination through which the consumer can access multiple sources to purchase the branded item. Through the use of the teachings herein, the brand can achieve fair and equitable treatment of the retail sources (also referred to interchangeably as retailers herein). Further, the shoppable address can be placed on any social, digital, influencer, or print media, providing a channel agnostic solution to analyzing the metrics of a particular post. Further details of enhancing a post with the shoppable address are described after first describing an environment in which the teachings herein may be implemented.

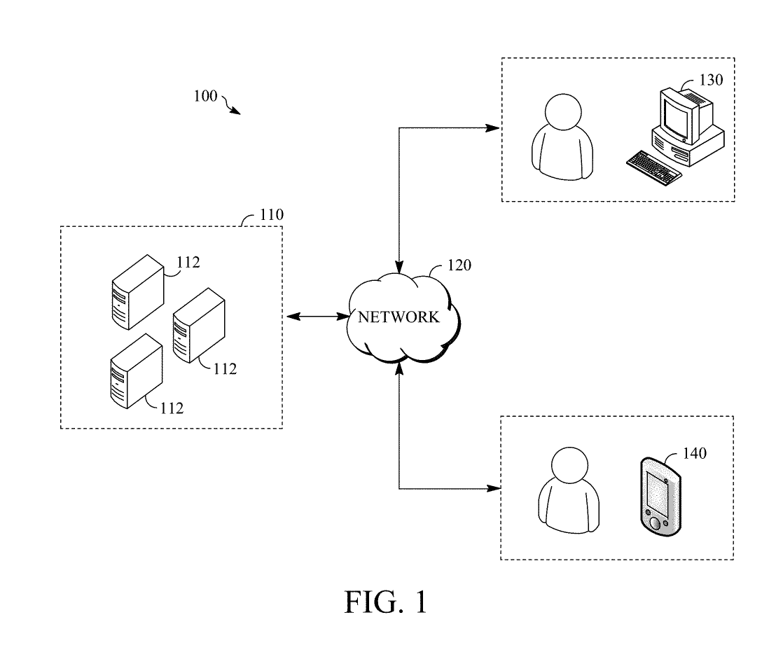

FIG. 1 is a block diagram that shows an example of a computing system 100 in which implementations of this disclosure may be incorporated. Computing system 100 may include a remote server system 110 having one or more server computers 112 connected through a wired or wireless network 120 to one or more user devices 130, 140 that are associated with users of the teachings herein. The users may comprise brands or influencers that enhance the content, a third-party operator that enhances the content on behalf of a brand, visitors to third-party websites (also called consumers), etc.

As part of remote server system 110, any configuration of the server computers 112 can be utilized. For example, certain of the operations described herein may be performed by the server computers 112 in the form of multiple groups of server computers that are at different geographic locations and may or may not communicate with one another, such as by way of network 120. The server computers 112 may be one or more database servers, one or more application servers, and/or one or more web servers. In one embodiment, the web server(s) and the application server(s) operate in the same running environment. The remote server system 110, and hence the computing system 100, can be configured to support all known and later developed browsers.

The network 150 can be one or more communications networks of any suitable type in any combination, including but not limited to local area networks, wide area networks, cellular data networks, and the Internet. The remote computing system 110 and the user devices 130, 140 can communicate with each other via the network 120.

The example of FIG. 1 shows the user devices of computing system 100 as a desktop computer 130 and a smartphone 140. Other types of user devices may also be part of the computing system 100 as long as the user device has the ability to access a webpage. For example, a watch, glasses or other computing device, wearable or otherwise, that can display information in the user's field of vision may be a user device. Another example of a user device is a laptop computer or a tablet.

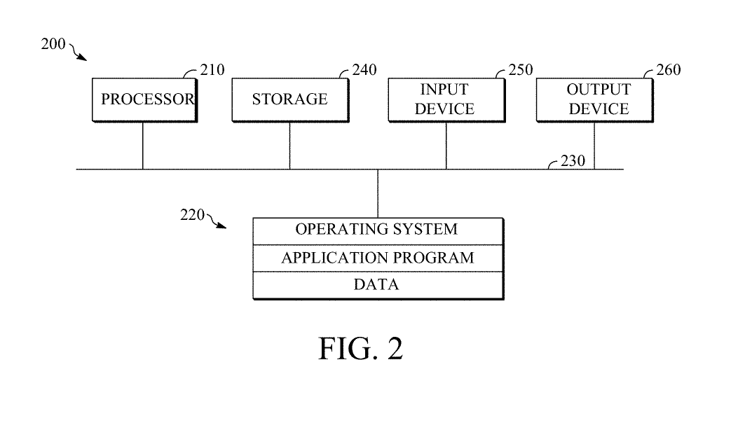

FIG. 2 is a block diagram of an example of a hardware configuration for a computing device 200 that can be used to implement a server computer 112 of the remote computing system 110. The same hardware configuration or a similar hardware configuration can be utilized to implement any or each of the user devices 130, 140.

Computing device 200 can include a processor 210. The processor 210 may comprise one or more central processing units (CPU). Alternatively, the processor 210 can be any other type of device, or multiple devices, capable of manipulating or processing information now-existing or hereafter developed. Although the examples herein can be practiced with a single processor 210 as shown, advantages in speed and efficiency may be achieved using more than one processor 210.

Computing device 200 can include a memory 220, such as a random access memory device (RAM) coupled to the processor 210 by a bus 230. Any other suitable type of non-transitory storage device or medium can be used as the memory 220. The memory 220 can include an operating system and an application program that operates according to the teachings herein. That is, the application program 224 can include software components in the form of computer executable program instructions that cause the processor 210 to perform some or all of the operations and methods described herein. The memory 220 can also include data that can be accessed by the processor 210 for use in the application program.

A storage device 240 can be optionally provided in the form of any suitable non-transitory computer readable medium, such as a hard disc drive, a memory device, a flash drive or an optical drive. One or more input devices 250, such as a keyboard, a mouse, a microphone or a gesture-sensitive input device, receive user inputs and can output signals or data indicative of the user inputs to the processor 210. One or more output devices 260 can be provided. One output device 260 may be a display device, such as liquid crystal display (LCD) or a cathode-ray tube (CRT), which allows output to be presented to a user.

Although FIG. 2 depicts the processor 210 and the memory 220 as being integrated into a single unit, other configurations can be utilized. The operations of the processor 210 can be distributed across multiple machines (each machine having one or more of processors) that can be coupled directly or across a local area or other network. The memory 220 can be distributed across multiple machines or devices such as network-based memory or memory in multiple machines performing operations that may be described herein as being performed using a single computer or computing device for ease of explanation. Although a single bus 230 is depicted, multiple buses can be utilized. Further, the storage device 240 can be a component of the computing device 200 or can be a shared device that is accessed by the computing device 200 via a network. Where the computing device 200 implements a server computer 112, the input device 250 and the output device 260 may be a combined network interface component that both receives requests from transmits data and/or instructions to a user device 130 or 140, such as receiving information that a user has selected a shoppable address and generating a scripted webpage as described in more detail hereinafter Computing device 200 thus be implemented in a wide variety of configurations.

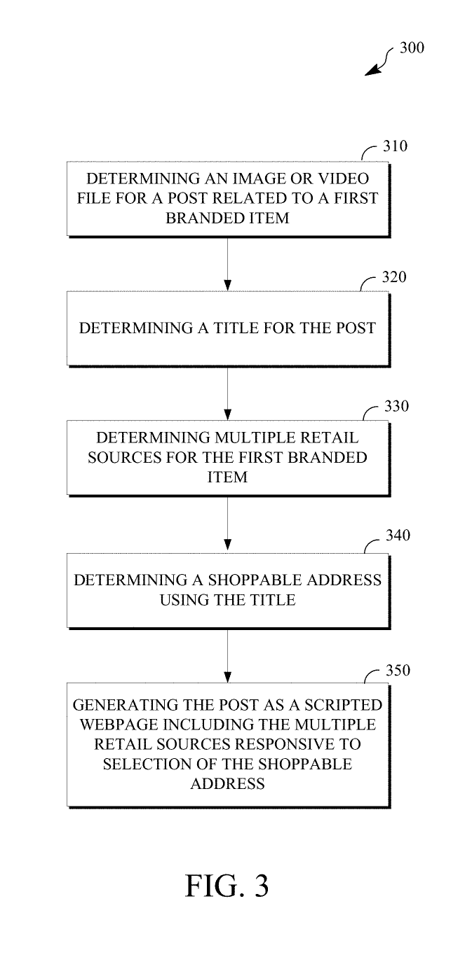

FIG. 3 is a flow chart showing an example of a process or method 300 for accessing brand data within a computing network. The method 300 does this using enhanced website content as described herein. The operations described in connection with process 300 can be performed at one or more computing devices 200, such as a server computer 112 of remote computing system 110. When an operation is performed by one or more computers, it is completed when it is performed by one computer. The operations described in connection with process 300 can be embodied as a storage device in the form of a non-transitory computer readable storage medium including program instructions executable by one or more processors that, when executed, cause the one or more processors to perform the operations. For example, the operations described in connection with the process 300 could be stored at the memory 220 of the computing device 200 and be executable by the processor 210 of the computing device 200.

At 310, an image file or video file for a post related to a first branded item is determined. Determining the image file or video file can include receive a selection of an image file or video file. For example, a host (also called a first) computing device within the computing network can provide a choice of image or video files for a user, such as from a gallery as described below, and the user can start the post by selecting one of entries in the gallery. The image file or video file can be obtained from a camera, a website, etc. The image file or video file can be obtained from a brand. The post may use a selected image file only, a selected video file only, or both an image file and a video file. The post may also use more than one image file, more than one video file, or both.

At 320, a title is determined for the post. The title may include an identification of the first branded item, but this is not a requirement. The title may be received from the brand or another user of the data acquisition system described herein.

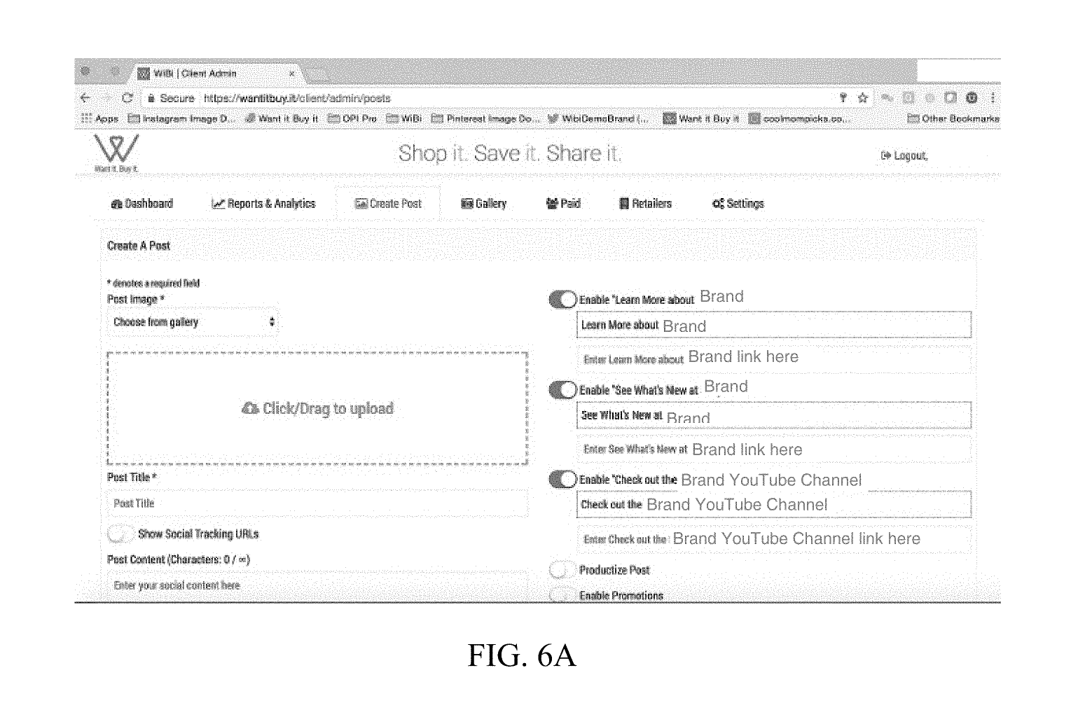

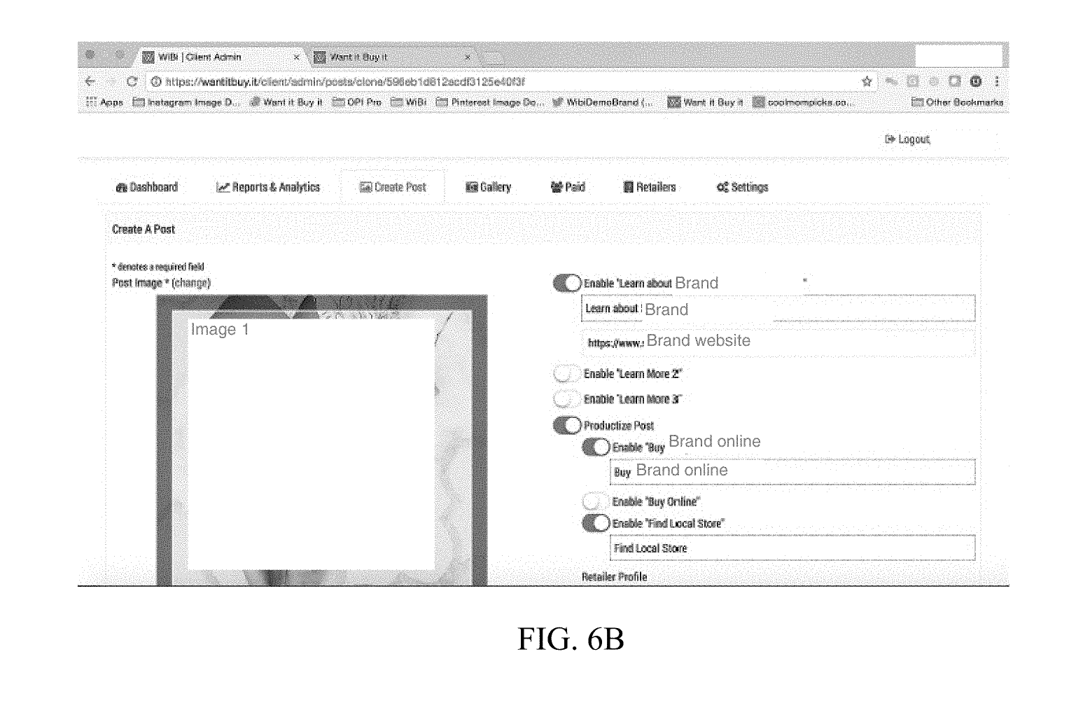

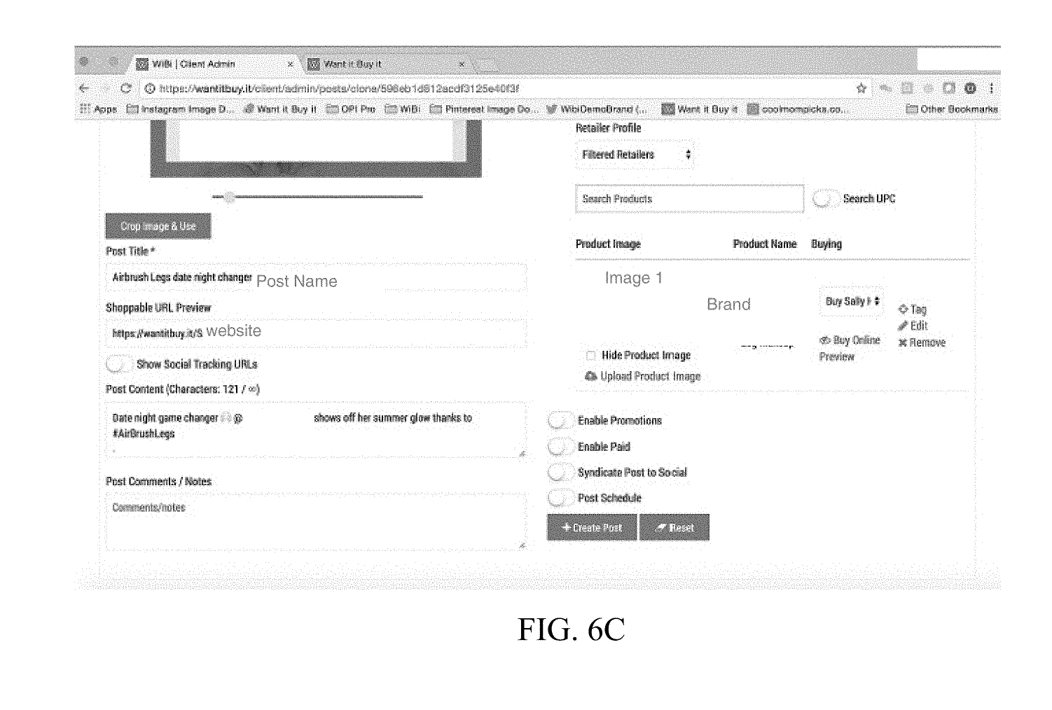

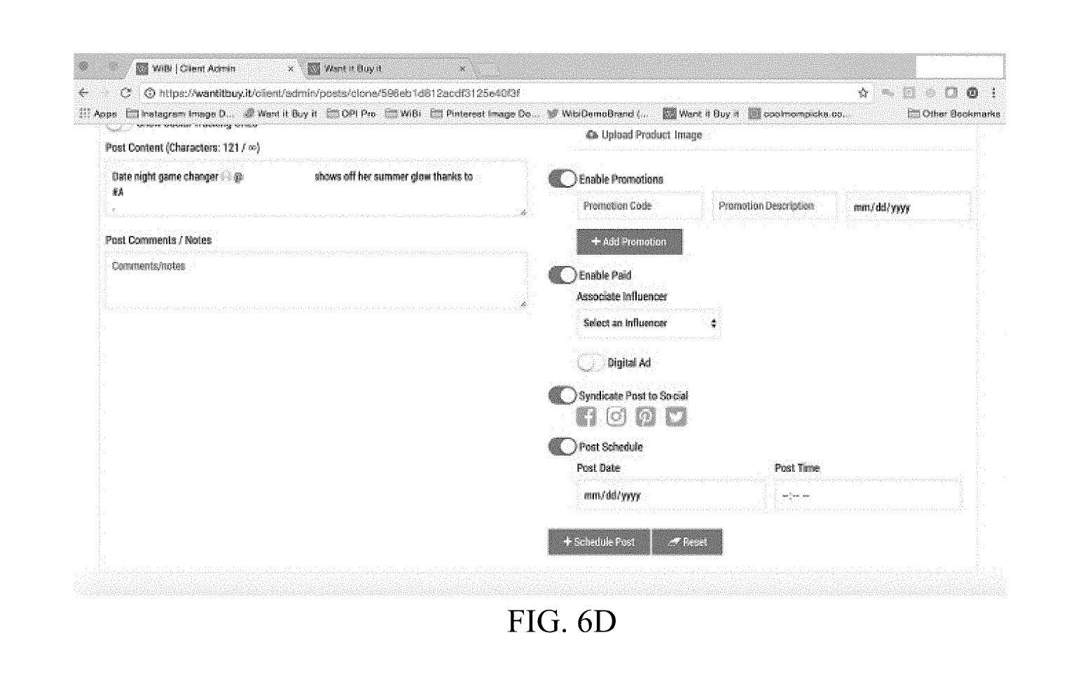

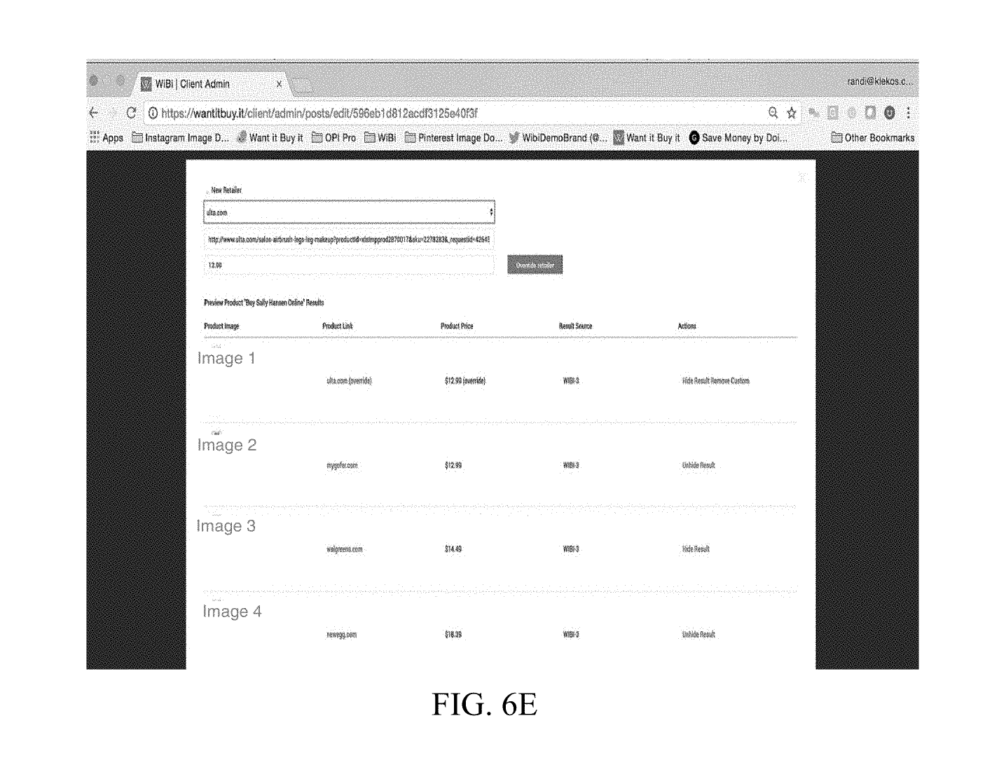

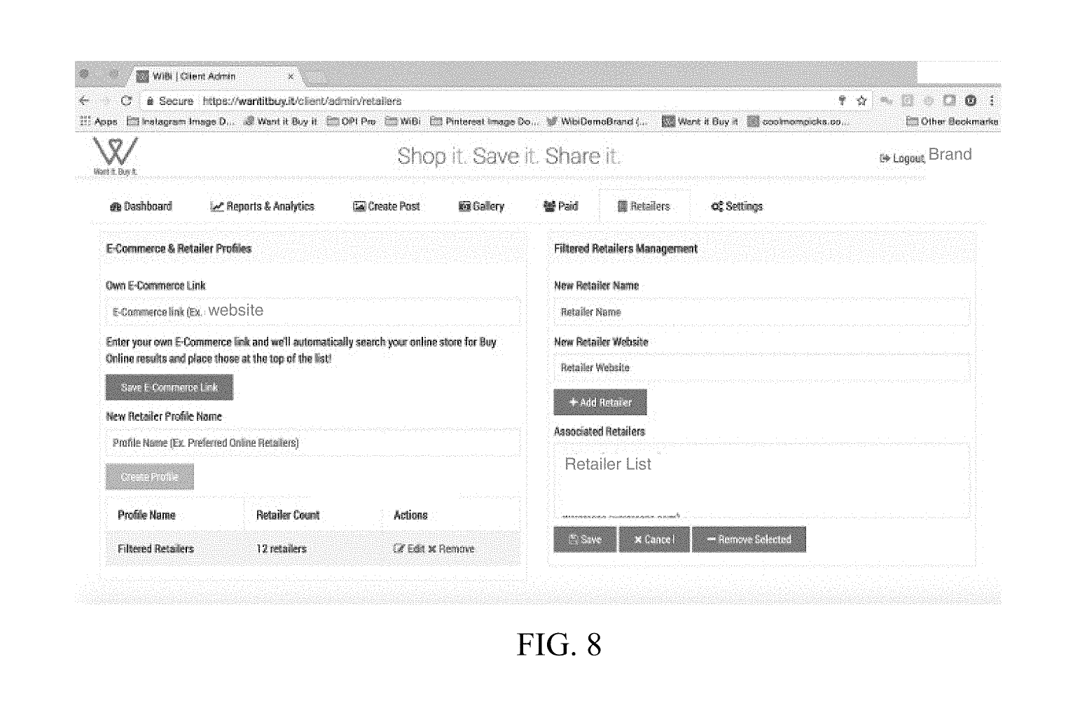

At 330, multiple retail sources for purchasing the first branded item are identified. Identifying multiple retail sources is described below with respect to FIGS. 6A-6D and 8.

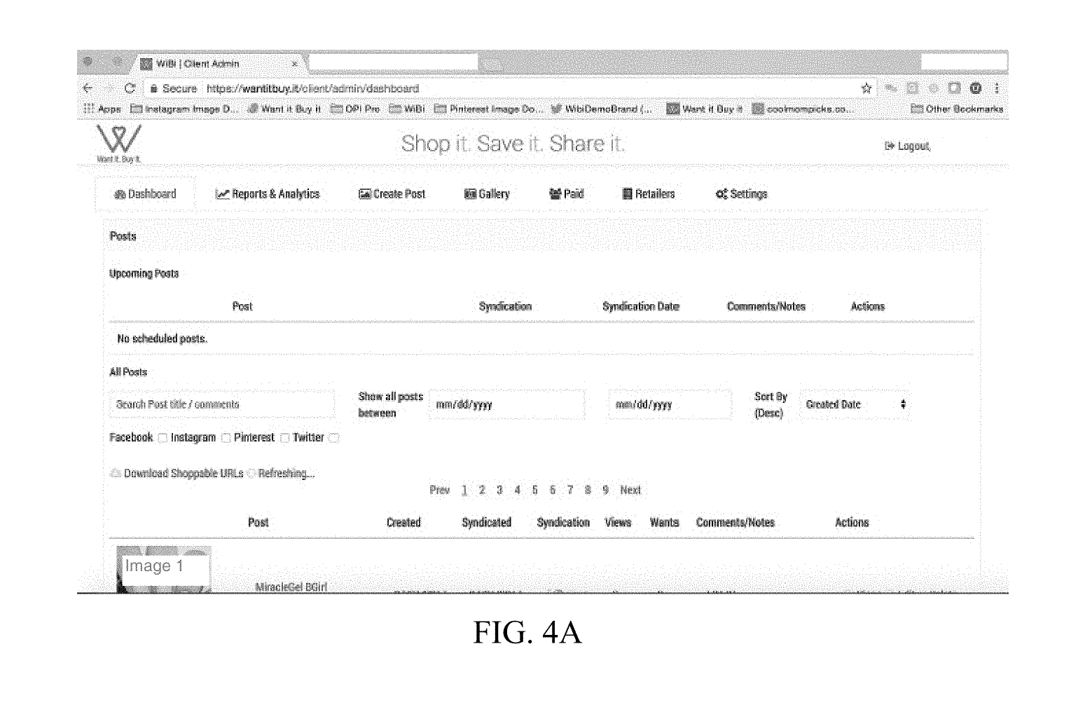

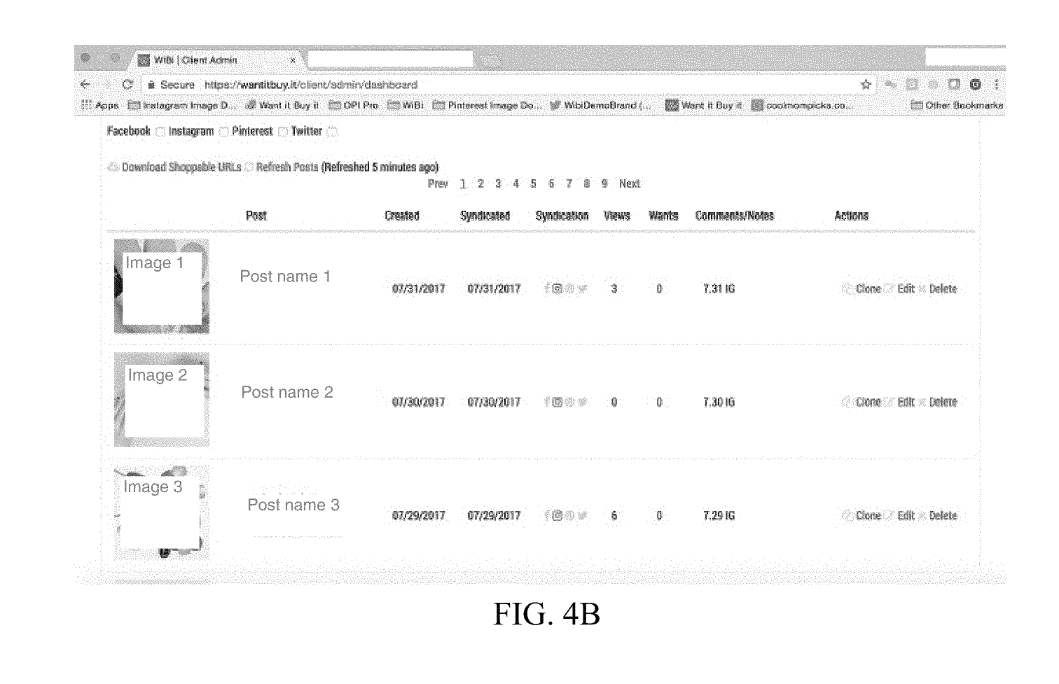

Other features of the post are discussed below with regard to FIGS. 4A-12.

At 340, a shoppable address is determined using the title. The shoppable address is a location within the computing network and may be a Uniform Resource Locator (URL). The shoppable address may be determined by using the title within a URL at a website operated by the first computing device. The title may be modified to replace spaces with characters, such as an underscore character. The shoppable address may subsequently be modified if desired by the user.

A user of the website operated by the first computing device may be included in association with content related to the branded item within a webpage. For example, the webpage may be associated with a third-party website operated by other than the first computing device (e.g., by other than the brand or user operating the data acquisition system on behalf of the brand). The content related to the first branded item may be the image file or the video file for the post. The third-party website may be an on-line retailer, or may be a social media platform. For example, the content may be an image posted on Facebook.

In some cases, where for example external linking from a webpage is not allowed for images or videos, the webpage may be scripted by the first computing device and populated with content regarding the first branded item and possible other branded items from a third-party website operated by other than the first computing device. For example, Instagram allows an external link from a webpage containing multiple images, but does not allow external linking from the images themselves. In this case, an external link to a webpage within the data acquisition system (using the first computing device) can be used, where the webpage mirrors the Instagram page but with posts created with respective ones of the images.

At 350, the post is generated as a scripted webpage of the website of the brand responsive to selection of the shoppable address. Selection of the shoppable address may be performed by “clicking” on the address, which is in the form of a hyperlink. The scripted webpage can include a respective link to retail sources of the multiple retail sources. For example the multiple retail sources may include at least one on-line retail source, at least one brick-and-mortar retail source, or a combination of one or more on-line retail sources and one or more brick-and-mortar retail sources. By listing several sources for the first branded product, the brand can increase the likelihood that the consumer will find an acceptable source.

Where the retail source is an on-line retail source, the link to the retail source can be a hyperlink directly to the first branded item within a website of the on-line retail source. In this way, the teachings herein may allow the brand to reduce the listing of competitor products or services to the first branded item. The on-line retail source can also be the commerce website of the brand itself. Where the retail source is a brick-and-mortar retail source, the link can comprise a hyperlink to contact information. For example, the contact information could include information for a brick-and-mortar retail source (e.g., a store) within a geographic area defined by the consumer. This could be achieved by accessing the location of the computer that the consumer is using, and may alternatively or additionally be selected by the consumer. The hyperlink can link to contact information in the form of a map indicating a location of the store. The hyperlink can link to contact information in the form of a telephone number for the store.

Further details of the method, apparatus, and system may be obtained by reference to the screenshots of FIGS. 4A-15E.

Reference is first made to FIGS. 4A and 4B, which are screenshots depicting a dashboard for a brand. Before accessing the services and information available through the website of the data acquisition system, a unique account is desirably established on a per-brand basis. In this case, the user is the brand or a third party acting on behalf of the brand, which may be referred to as a “brand client” of the data acquisition system herein. In some cases, the user of the data acquisition system may instead or additionally be an influencer. An influencer may be a blogger or other social media personality who, using the data acquisition system, markets themselves or their image through their posted content. An influencer operating on behalf of a brand is discussed in more detail herein. Consumers may also be users of some portions of the data acquisition system as discussed in more detail below. In one embodiment, the user account number is an email address of a user. Users, whether brands, influencers, or consumers can log in to their accounts with the data acquisition system using their email address and a selected password. Optionally, a user can sign in to the data acquisition system using a third party account, such as a Facebook account. The data acquisition system may place guidelines for selecting a password, and may require that each password be changed periodically.

A consumer is not required to register as a user of the data acquisition system. However, registration by the user allows them access to certain features unavailable to an unregistered user. In some implementations, registration may require a consumer provide demographic information such as age, gender, location, and other information. In order to track return on investment, registration can allow consumers to opt-in to save and/or track any of their purchases. In such cases, the PII of the consumer, the branded item details, and the retailer from whom the branded item was purchased may be available to the brand.

As seen in FIGS. 4A and 4B, the dashboard allows a brand client to manage its branded items and posts. FIG. 4A depicts the dashboard after the brand client logs in to the data acquisition system website. The brand client is presented with an overview of posts, including filters for the posts. For example, the brand client may show all posts as shown in FIG. 4B, or may filter posts based on a title, a date such as a created date or a syndicated date, and/or a third-party location of syndication, such as a social media platform.

The brand client can, as seen from the tabs 410, access a number of functions from the dashboard. The functions include “Reports & Analytics”, “Create Post”, “Gallery”, “Paid”, “Retailers”, and “Settings”. These functions are by example only as other names of the functions and other ways of accessing the functions are possible. In some implementations, certain functions may be omitted or added. For example, the function “Paid” may be omitted. In some cases, functionality may be provided directly at the dashboard. In this example, a user may clone, edit, or delete a post from the system. Cloning and editing a post are discussed below.

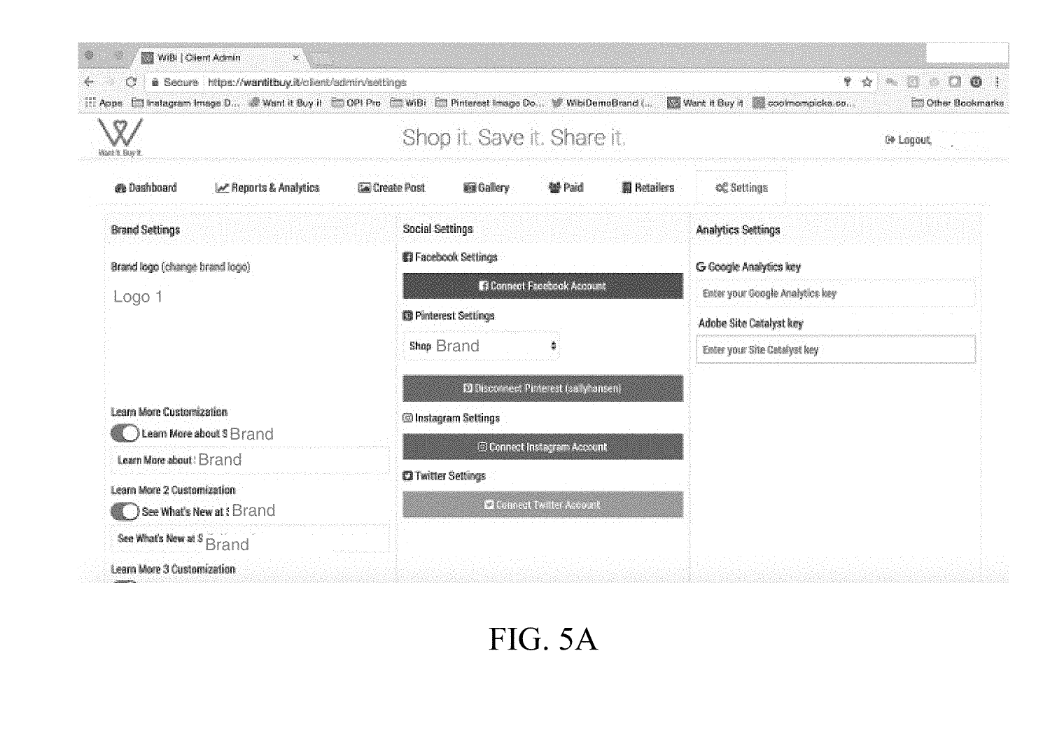

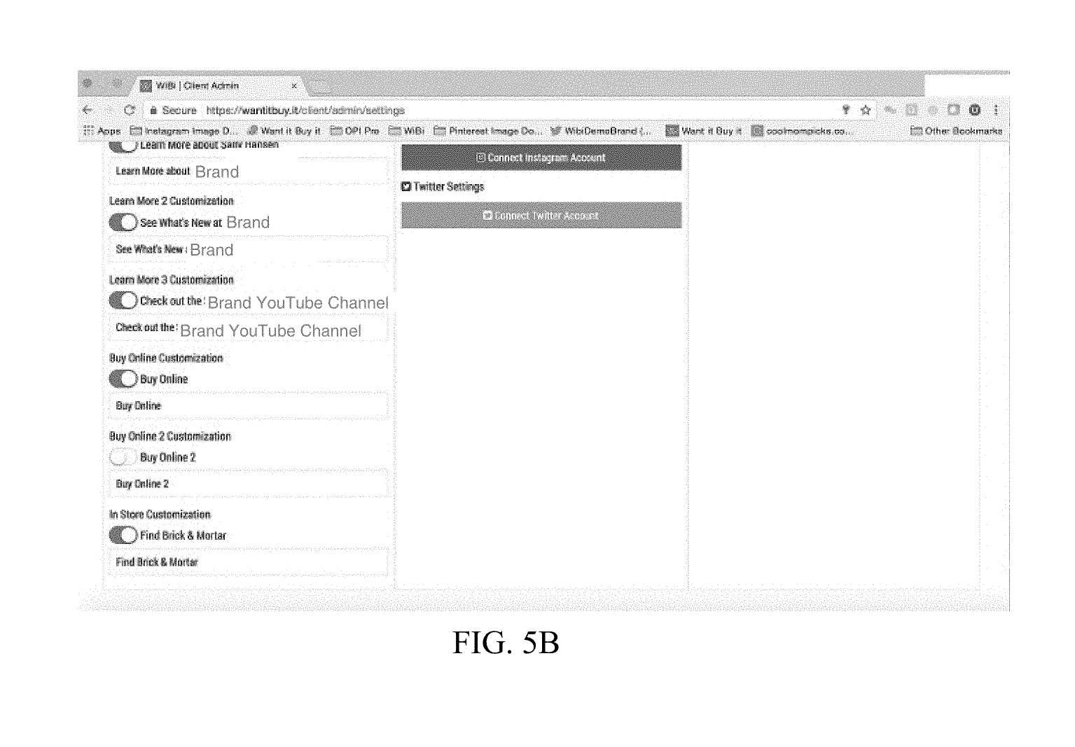

Upon contact with the tab labeled “Settings” in the dashboard, default settings are accessed. This is shown by example in FIGS. 5A and 5B, which are screenshots depicting settings for a brand, and more specifically for a post of a brand. As mentioned, these are default settings, which means that they are used in an initially created post for a brand. In other words, the settings provide default values for the creation of a post. In this example, the settings include brand settings, social settings, and analytics settings. The brand settings include the brand logo, up to three customizable descriptions for a “Learn More” field, up to two customizable descriptions for a “Buy Online” field, and one customizable description for an “In Store” field. Other than the brand logo, the brand settings include a toggle switch that determines whether they are included within the default settings for a post. In FIGS. 5A and 5B, two “Learn More” fields are toggled on, along with one “Buy Online” field and the only “In Store” field. The social settings include account information for social media platforms. In this example, only a Pinterest account is set. The analytics settings allow for the inclusion of third-party keys for analytics. In this example, a Google Analytics key and/or an Adobe Site Catalyst key may be entered. These settings are exemplary only and the same or additional or other settings may be presented to the brand client within the scope of this disclosure.

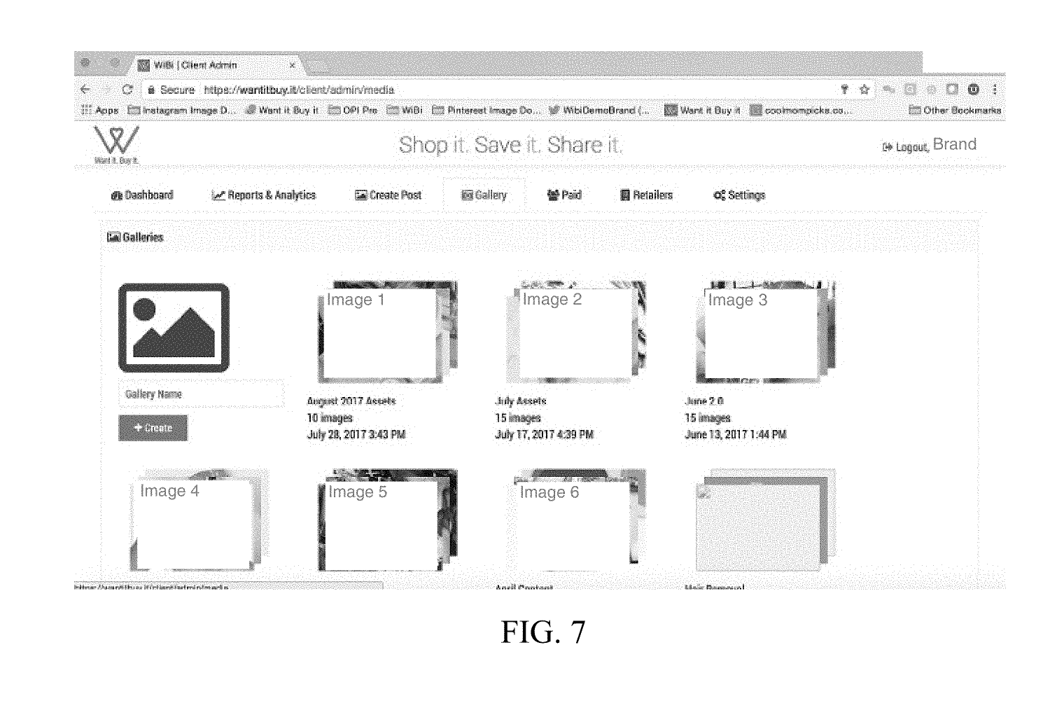

FIGS. 6A-6E are screenshots depicting creation of a post for a brand. FIG. 6A is a partial screenshot of a screen that may be shown responsive to selection of the tab 710 labeled “Create Post” within the dashboard. As can be seen, required fields are posting an image and posting a title. Image, as used here, refers to an image and/or a video. An image may be uploaded from a user's computer. An image may be selected from a gallery. One example of a gallery is partially shown in the screenshot of FIG. 7. The gallery may also be accessed by selecting the tab 710 that is labeled “Gallery” in the dashboard. The gallery includes images in previous posts. In some cases, the gallery includes the previous posts to which the images belong. According to some implementations where the gallery includes the previous posts, selection of an image operates similarly to the clone action referred to briefly in FIG. 4B. Namely, the settings of post are duplicated. Then, the user changes the post title post title from the previous title, thus changing the shoppable address. In FIG. 6C, the shoppable address is shown as a shoppable URL, and these terms may be used interchangeably. In the system, it is desirable that each post have a unique title. It may be required that each post have a unique title and/or a unique image. Where a unique image is required, the use of the gallery also involves the user changing the image from that in the gallery used to populate the fields of the post.

FIGS. 6A and 6B show that default settings for a field in the post may be changed. For an individual post, a field may be toggled on or off and/or the description for a field may be changed. For example, FIG. 6A shows default entries for each of the three “Learn More” fields described with regard to FIGS. 5A and 5B. As shown in FIG. 6B, which is a similar shot of FIG. 6A with some fields completed, including uploading of an image, two of the “Learn More” fields are toggled off, and the description of the third is changed. FIG. 6C is a continuation of FIG. 6B, showing the default shoppable URL for the post determined using the post title. Desirably, but not necessarily, a product image may be uploaded as shown in FIG. 6C. The product image and other content or data may be uploaded to the system via an API in some embodiments.

FIG. 6C refers to a “Retailer Profile”, where the entry for this field indicates “Filtered Retailers”. Retailers may be established by selection of the tab 710 that is labeled “Retailers” in the dashboard. Stated generally, a user can create retailer profiles comprising a collection of retailers (on-line retail sources and/or brick-and-mortar retail sources) for inclusion in availability searches for a branded product. Custom profiles can include any variation of retailers. For example, the user can create an exclusive retailer profile that limits availability of the branded item to a single retailer, for example the brand's own e-commerce website. This can also be useful where a brand has an exclusive agreement with a retailer to sell a certain item by excluding all other retailers. In another example, the user may create a retailer profile for big box retailers. Through the use of retailer profiles, the user can explicitly exclude a retailer from or add a retailer to one or more posts. The retailer profiles can be customized as desired by the user (e.g., the brand). Where a retailer is not included in the dynamic search result (e.g., where the retailer has pool search engine placement for example or a product is new to a retailer), the retailer may be manually added. Pricing may be returned from the retailer as result of the search, and a user may override the price by manually specifying a price. Each of these actions regarding a retailer or price may be taken by accessing the “Buy Online Preview” shown in FIG. 6C. The screen that results when “Buy Online Preview” is selected is shown in FIG. 6E. The dynamic search may be established on a per-post basis using a description entered by a user and/or by searching a Universal Product Code (UPC) as shown by the search settings in FIG. 6C.

An example of a webpage for managing retailers is shown in the screenshot of FIG. 8. If the brand has its own webpage for offering branded items, its e-commerce link may be added. In some implementations, the brand's e-commerce link is placed at the top of results of on-line retailers of a branded item. Initially, at least one retailer profile is created having a retailer profile name. The profile can include one or more on-line retailers. For example, the profile “Filtered Retailers” referred to in FIG. 6C has 12 retailers. Once at least one retailer profile is named and created, that retailer profile can be managed as shown by the section labeled “Filtered Retailers Management” in FIG. 8. Through the use of different profiles, an individual post for a branded item can be targeted by the user to different on-line retail sources. The on-line retail sources can also be used with geolocation and/or entry of location information (e.g., a zip code) of a consumer as discussed below to locate the closest brick-and-mortar retail sources (e.g., stores) to the consumer where the branded item can be purchased.

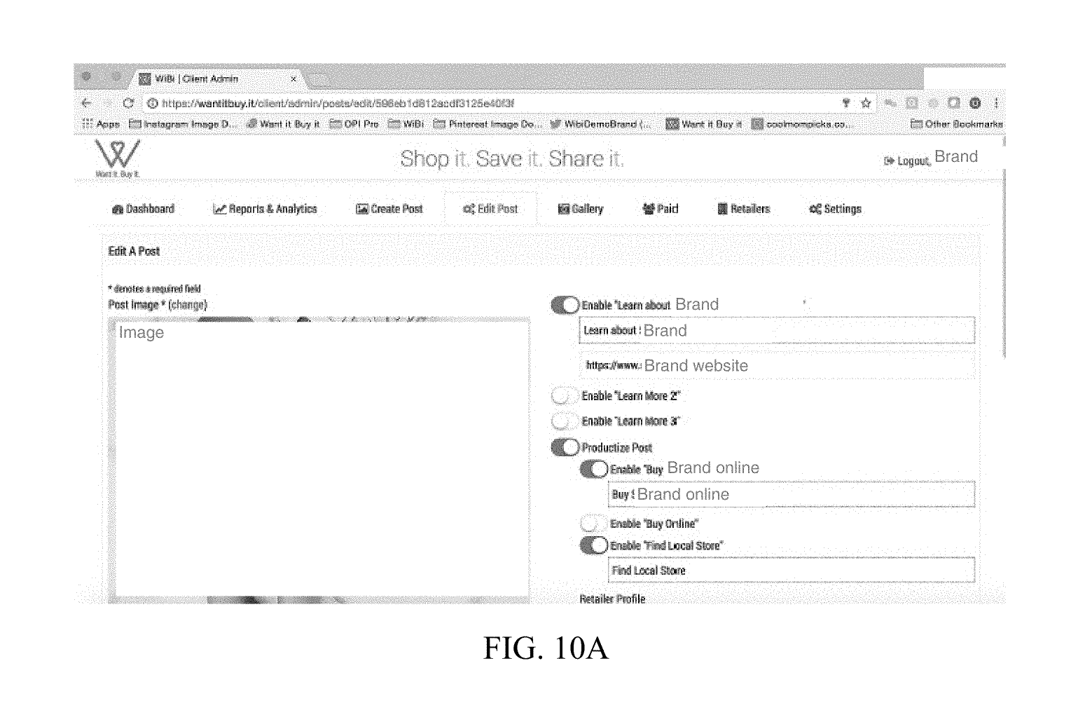

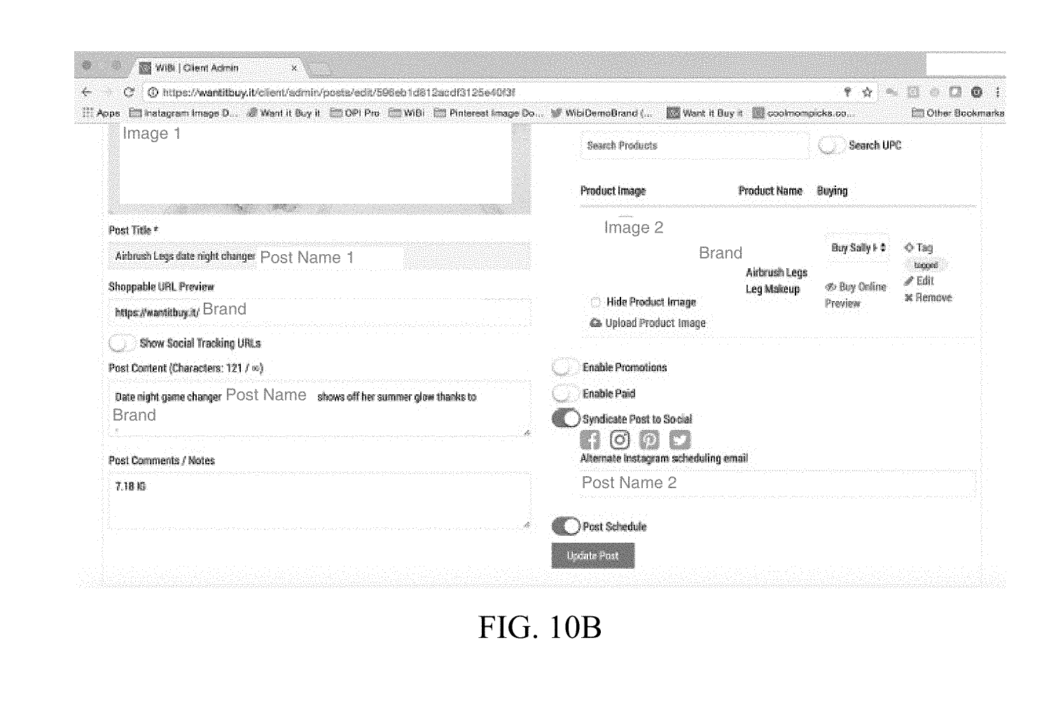

This feature of using retailer profiles allows for combinations of branded items to become shoppable together as discussed in additional detail with regard to FIGS. 10A and 10B below. For example, an image may promote nail polish, lipstick and earrings, all sold at a different set of multiple retailers. Each of these products may have its own unique set of search results from retailers.

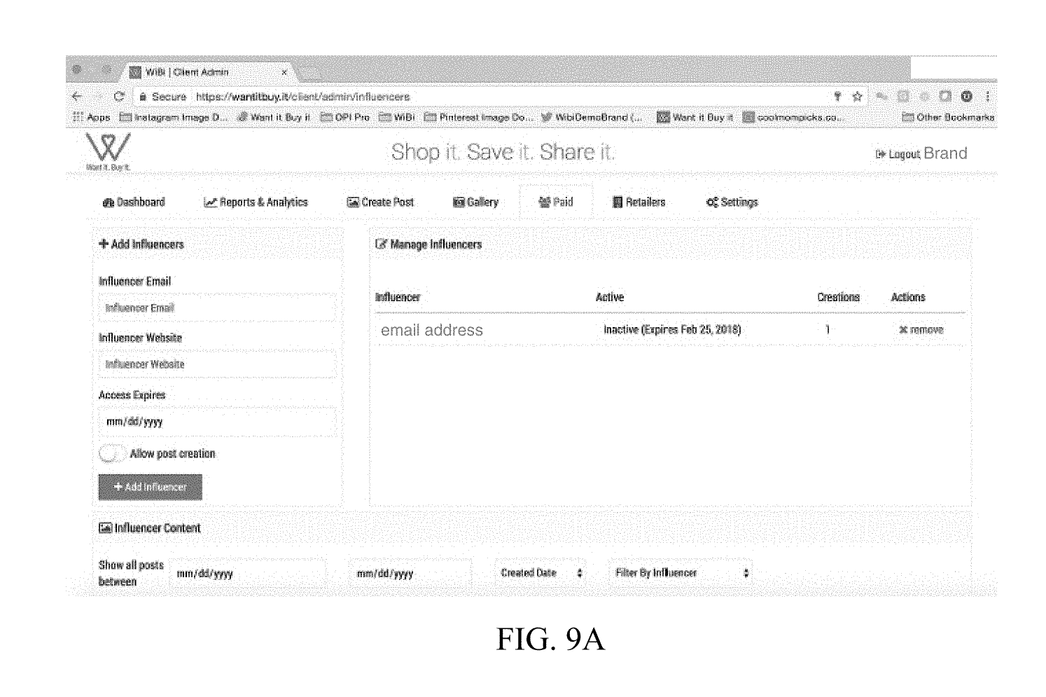

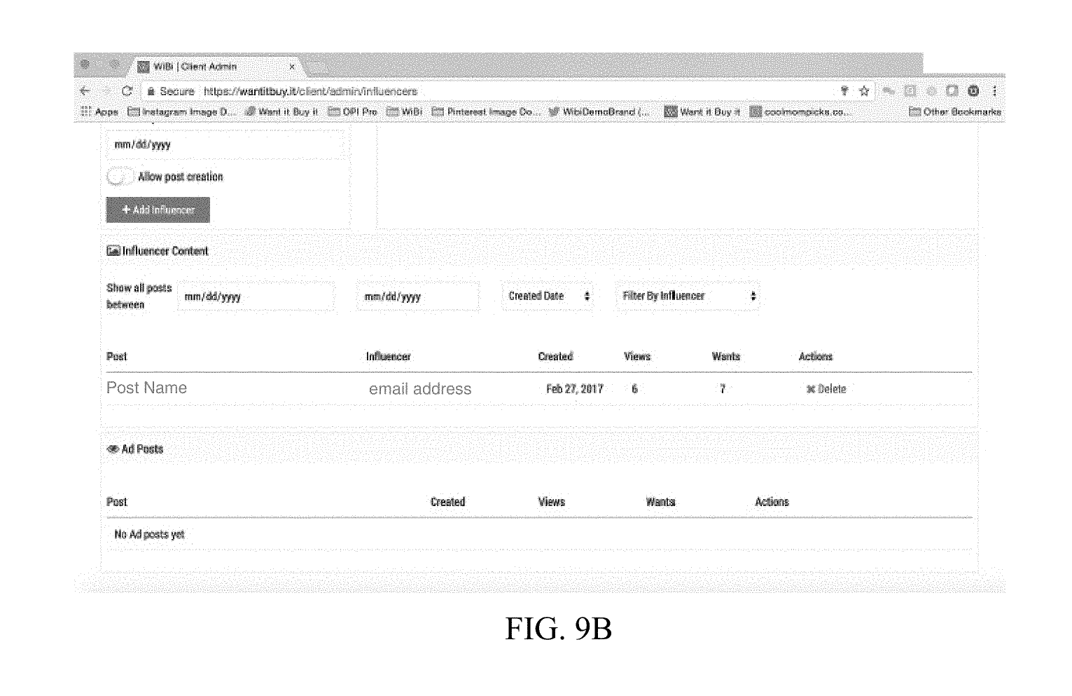

Referring again to FIGS. 6A-6E, the post is customizable using a wide range of fields. For example, FIG. 6C shows toggle switches for fields that are not included in the settings previously described—namely “Enable Promotions”, “Enable Paid”, “Syndicate Post to Social”, and “Post Schedule”. FIG. 6D shows a similar portion of the screen of FIG. 6C where each of these fields is toggled on by a user for the post. The field “Enable Promotions” allows the user to enter promotion information for any promotions offered by the brand for the brand item identified in the post. The field “Enabled Paid” allows the selection of paid digital ad or an influencer to be associated with the post. FIGS. 9A and 9B are screenshots depicting the management of digital ads and/or influencers for a brand. This function for a brand may be accessed by selecting the tab 710 labeled “Paid” in the dashboard.

In the example of FIGS. 9A and 9B, one influencer is shown. Optionally, the influencer can create posts. The data related to an influencer and the filtering of the influencer content shown are by example only.

Referring again to FIG. 6D, “Syndicate Post to Social” allows the user to designate a social media platform for syndicating the post. As shown, the social media platforms include Facebook, Twitter, Instagram and Pinterest. The account settings for these social media platforms are obtained from the settings described previously with regard to FIGS. 5A and 5B.

After creation of a post, the post may be edited. FIGS. 10A and 10B are screenshots depicting editing of a post for a brand, and may result from selecting the tab 710 labeled “Edit Post” in the dashboard. Alternatively, FIGS. 10A and 10B may result from selecting “Edit” in the listing of posts in the dashboard shown by example in FIG. 4B. While not all fields used to create the post are shown in these screenshots, in some implementations, every field used to create a post may be edited. FIGS. 10A and 10B are useful to illustrate a couple of features of the system not previously described. FIG. 10B, for example, shows a selection of Instagram for syndicating the post. This allows the addition of an alternate Instagram scheduling email as shown. Together, FIGS. 10A and 10B are also useful for showing the “Tag” function for a post. FIG. 10B shows that the product is tagged, while FIG. 10A shows the tag. The tag is labeled “1” because this is the first branded item of the post. By using the search field to search for another branded item from the brand client or another brand, a post with multiple branded items may be formed. More specifically, another branded item can use the same or a different retailer profile from the retail profile used to identify retail sources of the first branded product. Another image for the second branded item may be uploaded by the user using the “Upload Product Image” selector. The second branded item may then be tagged using the “Tag” function, and will be assigned a tag labeled “2” in a like manner to the tag for the first branded item. This can continue for any number of branded items within the same image or video for a post. This functionality eliminates the need to flip between websites and/or webpages seeking retail sources for the different branded items.

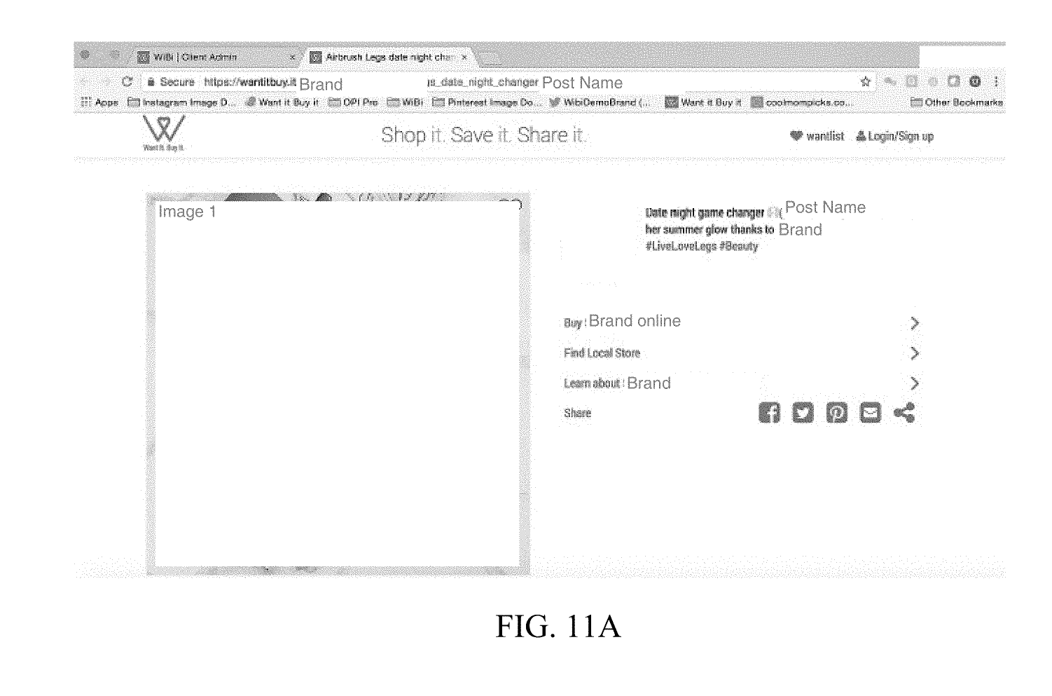

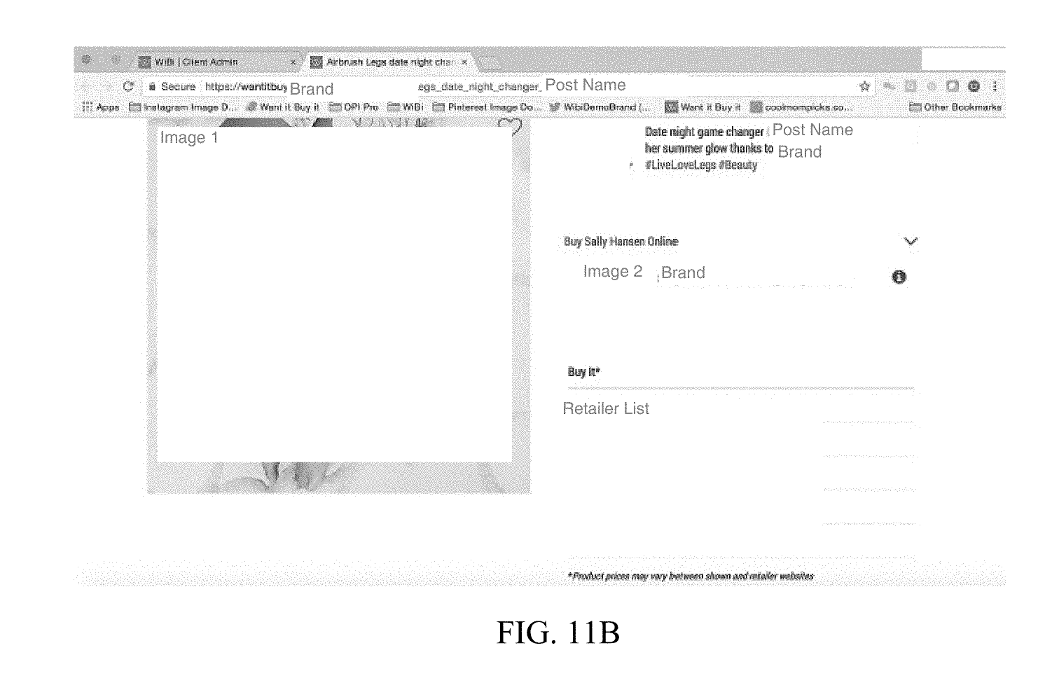

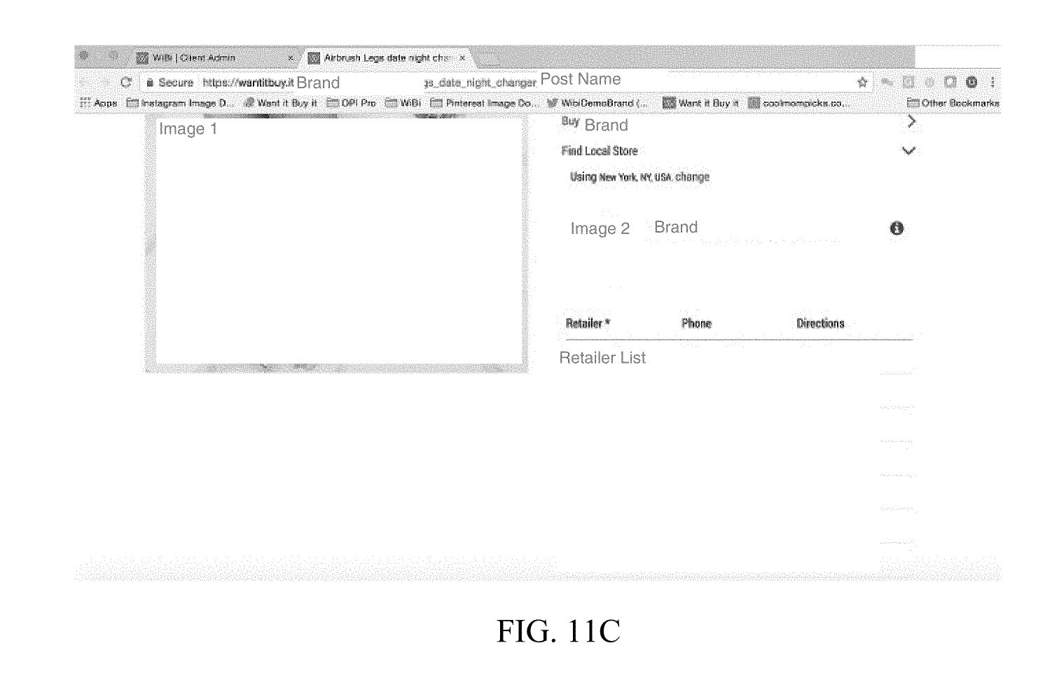

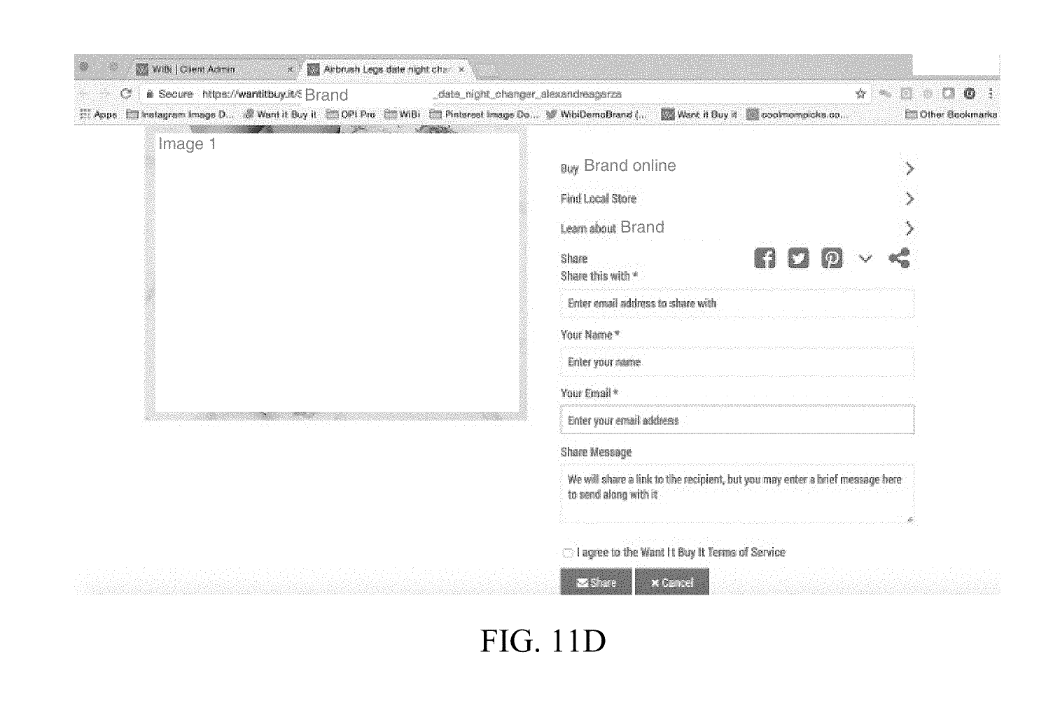

FIGS. 11A-11D are screenshots depicting a post at a shoppable address. The post may have the form of a scripted webpage where the scripted webpage is based upon fields or parameters defined when creating the post. These may be stored in various tables and fields in a database. This represents the content that will be seen by a consumer when they select a link identifying the shoppable address.

In operation of the system, for example, a consumer visits a third-party website where a brand client maintains a page advertising products and/or services, or posts content advertising products and/or services. The consumer is interested in one or more items on the third-party webpage. The webpage, or content on the webpage such as an image or video includes a link that was created by the system and that has description provided by the brand client as described above in the creation of a post. The user clicks on the generated link and is taken to a webpage on the data acquisition system website that has been scripted according to information provided to the system. On the scripted webpage, the consumer can find out information on the branded items referenced on the third-party webpage. For example, the consumer can purchase the products or services online; can find local retailers who sell the products and services; can save product or service information; and can request that links to purchase the products and services be transmitted to any device of the user for example by email or SMS, or by posting to social communities.

Starting with the specific example shown, FIG. 11A shows the post without any results expanded. The actions that can be taken are shown as “Buy Brand Online”, “Find Local Store”, a “Learn More” entry, and “Share”. Collectively, they may be referred as “call to actions”. FIG. 11B shows the results of the search for on-line retail sources that may be accessed by expanding the action “Buy Brand Online”. Each entry is associated with an on-line retail source and includes a link to that source. Preferably, the link is a hyperlink directly to the branded item. Also included is a price that may be returned from the search of the retailer website or may be manually entered by the user. If no price is returned, the price may be replaced with a message, such as “Buy now”.

Although the system shows the results of the dynamic product search in the form of a respective link for the on-line retail sources and a price in FIG. 11B, the dynamic search searches for products and services at on-line retailers throughout the globe through integration with industry leading data providers and search engines that provide product information and availability for on-line retailers. In addition to product and service availability, additional product and service information may be found and presented, such as product specifications, quantities, delivery zones, and other information.

FIG. 11C shows the results of the search for brick-and-mortar retail sources that may be accessed by expanding the action “Find Local Store”. Each entry is associated with a brick-and-mortar retail source and includes one or more links including contact information for the source. In this case, the contact information is its phone and directions, and the links include respective hyperlinks at the label “Call to confirm” and “Directions”. As can be seen by the field at the top of FIG. 11C, the local stores have a geographic area of New York, N.Y. The consumer can change this by selecting “change” and entering a different location, such as a zip code.

For a “Learn more” action, such as that shown in FIGS. 11A and 11D, selecting the action will transfer the consumer to the default webpage identified in the settings or to a modified webpage established for the post when creating or editing the post.

FIG. 11D shows the results of the expanding the email icon of the “Share” action. The consumer can share a link (e.g., the shoppable address) with another consumer. The “Share” action also includes icons for syndicating the post to Facebook, Twitter, and Pinterest, which will bring up alternative information needed for the syndication as necessary, such as the consumer's account information. Other social media platforms may be used. Generally, this allows the brand client to permit a consumer to syndicate the post to their own social community websites. As shown, the “Share” action includes the additional ability to use, through selection of the network symbol, an embeddable content widget that can be used with any website having a Content Management System (such as, for example, Blogger.com, Wordpress, Brand Owned Sites, etc.). This can shorten the shoppable address and embed the link without the image of the post. In this way, a consumer can make any image on their blog shoppable, for example. When a consumer mouses over an image on a website with embedded content from the system, details of the branded items and buying options may pop up in a dialog box from the image on the website having the embedded content.

Although not expressly shown in FIGS. 11B and 11C, where multiple branded items are identified in the post, expanding the display can include information for each branded item together, or the branded items may be presented to select between them to reveal further information regarding the retail sources. In operation, a photograph or rendering of an ensemble of separate items on a third-party webpage may be presented that creates a “look” or other ensemble of related products or services. The consumer (a user of the third-party website) can click on the shoppable address and be presented with the scripted webpage of the system whereupon information on how to order the individual items is presented as previously described. Alternatively, or additionally, the system may provide that the consumer clicking on the image will list the available items, or the consumer clicking on the tagged item will present purchase information for the tagged item.

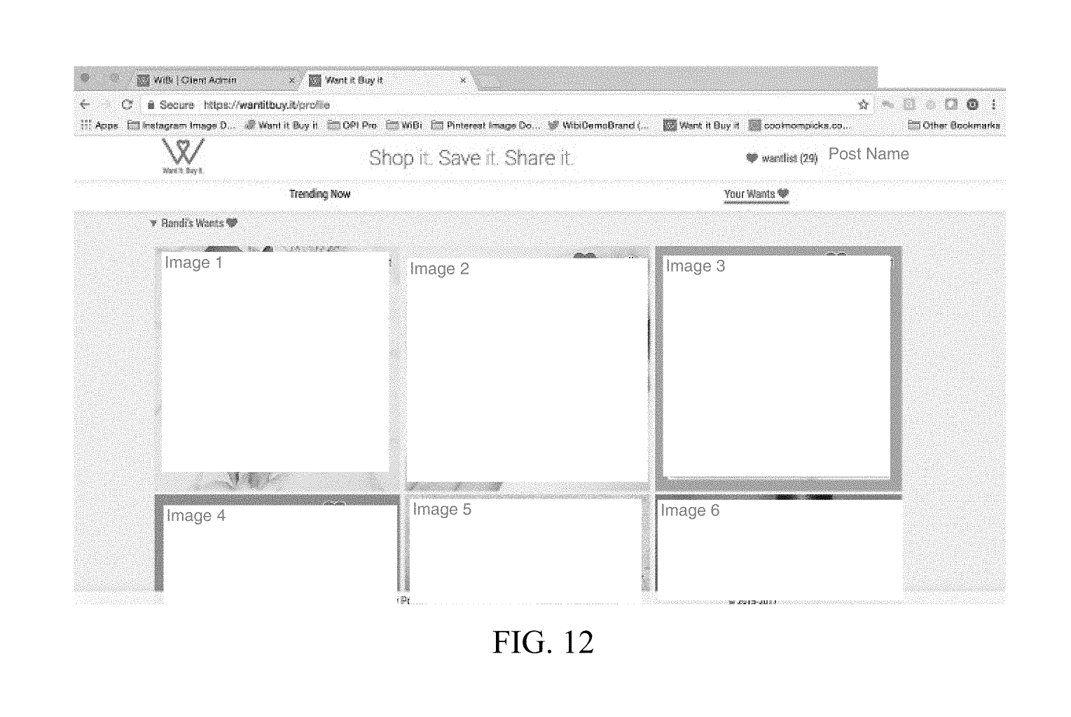

When a consumer registers with the website of the system, the consumer may have functionality not available to consumers who do not register. One such function is the ability to “want” a product or service. “Wanting” a product or service is an action that is initiated by the registered consumer by clicking an icon associated with that product or service, for example the heart icon shown with the image in FIG. 11A. By “wanting” a branded item, the consumer saves the item to a “wantlist” shown at the top of FIG. 11A. As shown in FIG. 12, the “wantlist” comprises a collection of items (in the form of the images or video for posts) that he/she is interested in. The data collection of “wants” and optionally views of individual posts can be used for real-time trending by populating entries in a list (e.g., a collection of images) available by selecting a link labeled “Trending Now” as also shown in FIG. 12. The information in “Trending Now” can be collected across one or more brands. The “Trending Now” website provides consumers accessing the data enhancement system the ability to review content from multiple brands. It also allows the brands to extend the life cycle of post related to a branded item to other than what might be provided by platforms on which it is posted.

The want lists may be used for marketing purposes as one part of the Customer Relationship Manager (CRM) functions of the present disclosure. Brand clients may run reports including these lists and other input to determine what the engagement factors are for their product/service posts. Additionally, brand clients may have sent to them, or may download contact information of consumers who have included their branded items in a want list for direct marketing capabilities.

In the settings discussed with regard to FIG. 5A, integration of the system with enterprise analytics packages is an option. Even without such integration, the system offers advanced reporting and analytics capabilities to a brand client (e.g., on a per-post, per-platform basis). Metrics captured may include post views, branded items (e.g., products) viewed, shoppable URL Views by digital or social media platform (e.g., Facebook, Twitter, Instagram, Pinterest, Influencer, blog, brand website, digital ads, etc.), buying/conversion activity, views of Buy Online, views of Find in Store (e.g., buy local), views of Learn More, “wantlist” activity, date/time of these views, geographic location of the viewers, etc. In some cases, a post may be associated with print media (e.g., a magazine, etc.) via image recognition. Upon scanning the image (e.g., using a mobile device), the consumer is provided with the scripted webpage when the scanned image is recognized.

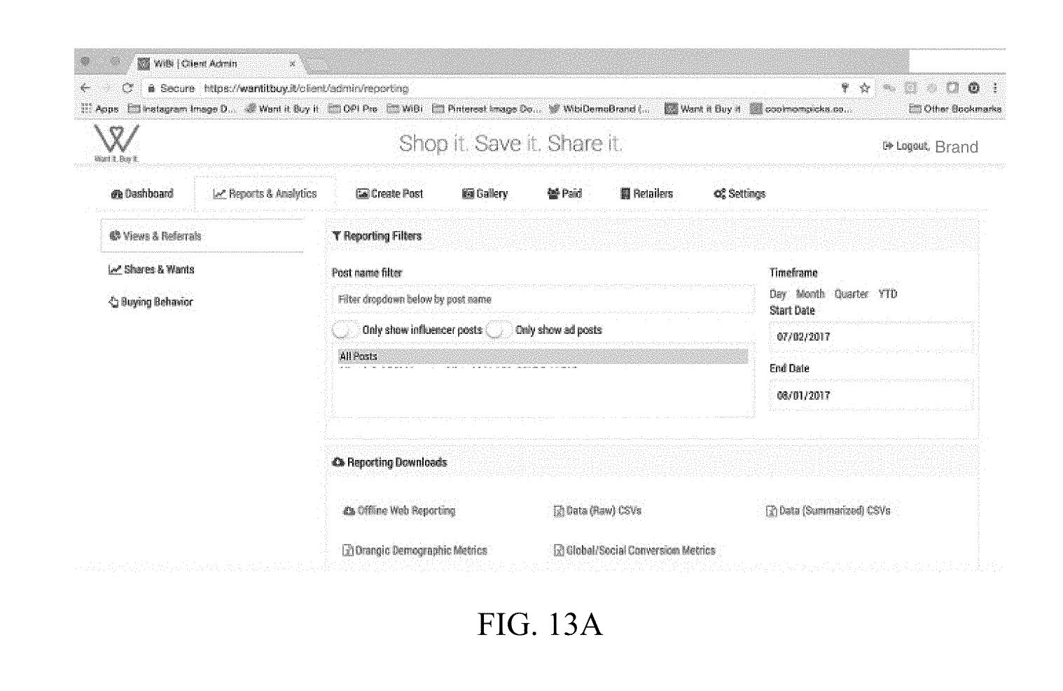

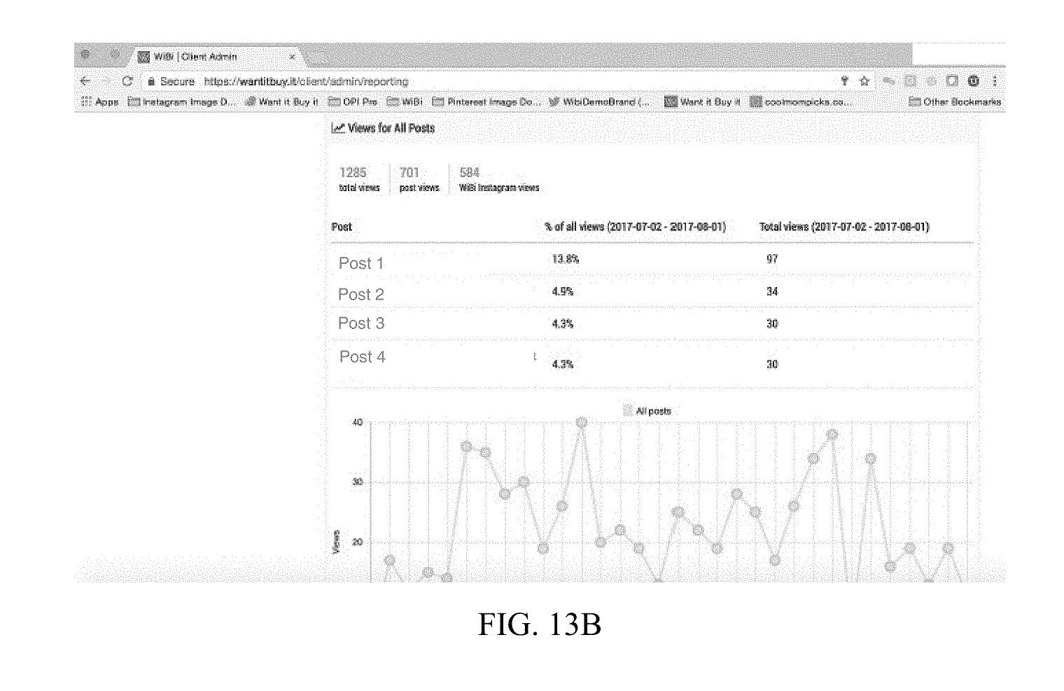

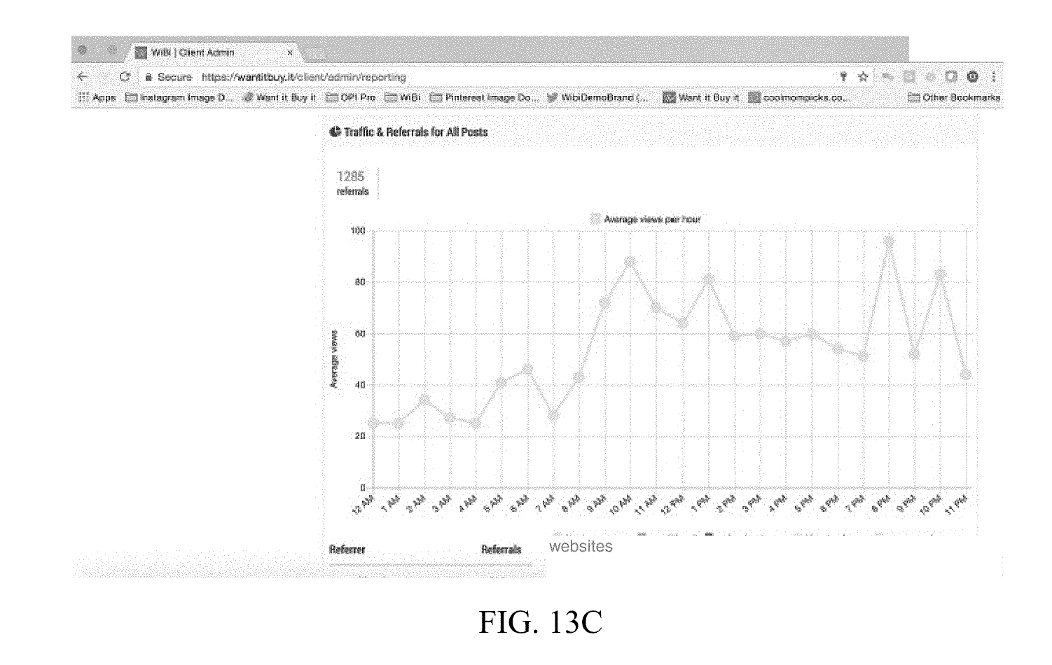

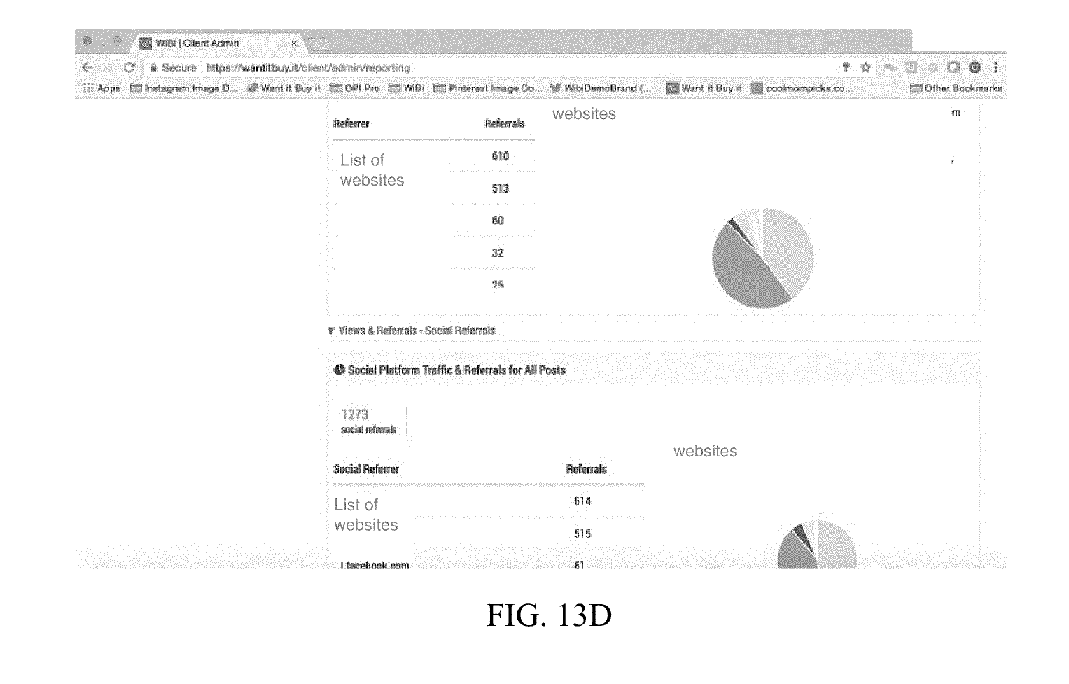

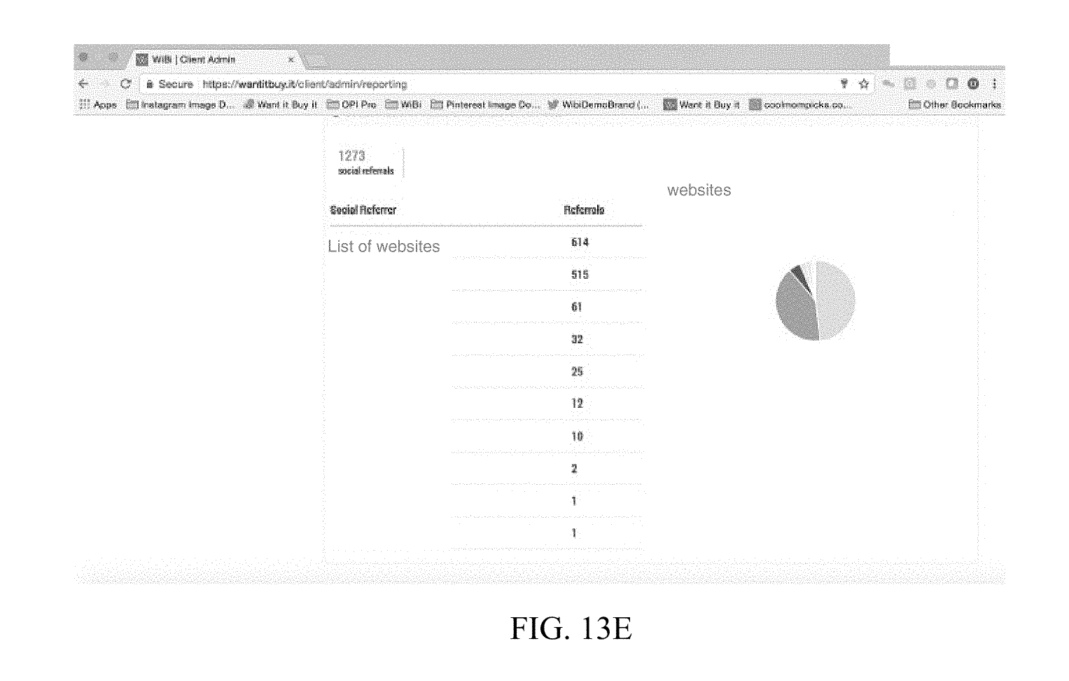

Specific examples of post reports and analytics are shown in FIGS. 13A-15E. Post reports and analytics may be accessed by selecting the tab 710 labeled “Reports & Analytics” in the dashboard. In these examples, the reports and analytics are broken down by the type of information covered by the reports and analytics. To the left of FIG. 13A are three tabs, “Views & Referrals”, “Shares & Wants”, and “Buying Behavior”. The tab “Views & Referrals” is selected, so FIGS. 13A-13E are screenshots depicting the post reports and analytics related to views and referrals. FIG. 13A more specifically shows reporting filters that may be used to limit the data used to generate the reports and links for downloading reports. Filtering may be performed by post name, whether the post was generated by an influencer or is an ad, and time frame (e.g., when the post was generated). FIGS. 13B-13E show various statistics, which may be included a table, a summary, a graph, or combinations of these display techniques. The statistics related to views and referrals may be broken down by views per day or average views per hour of one, some, or all posts, referrals to the platform by website or by social media platform, etc.

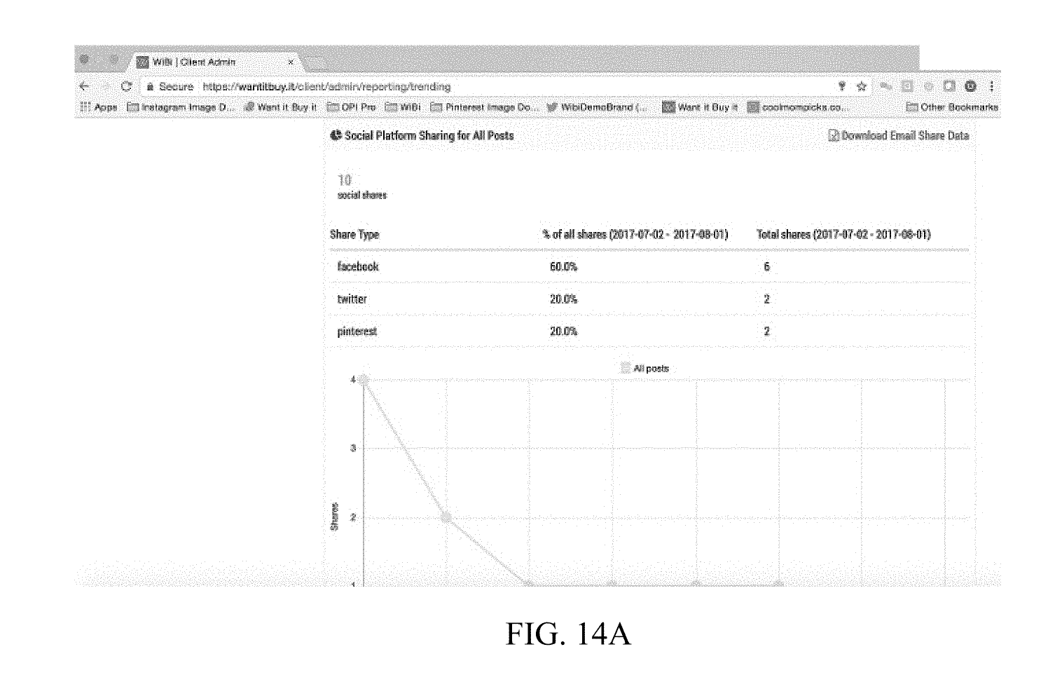

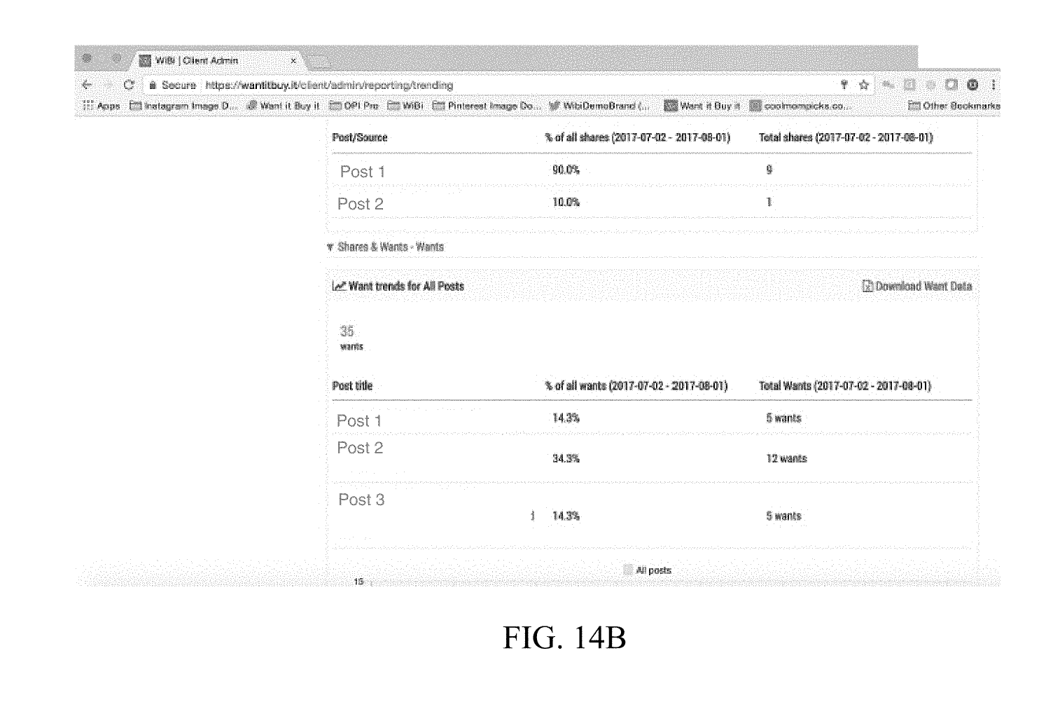

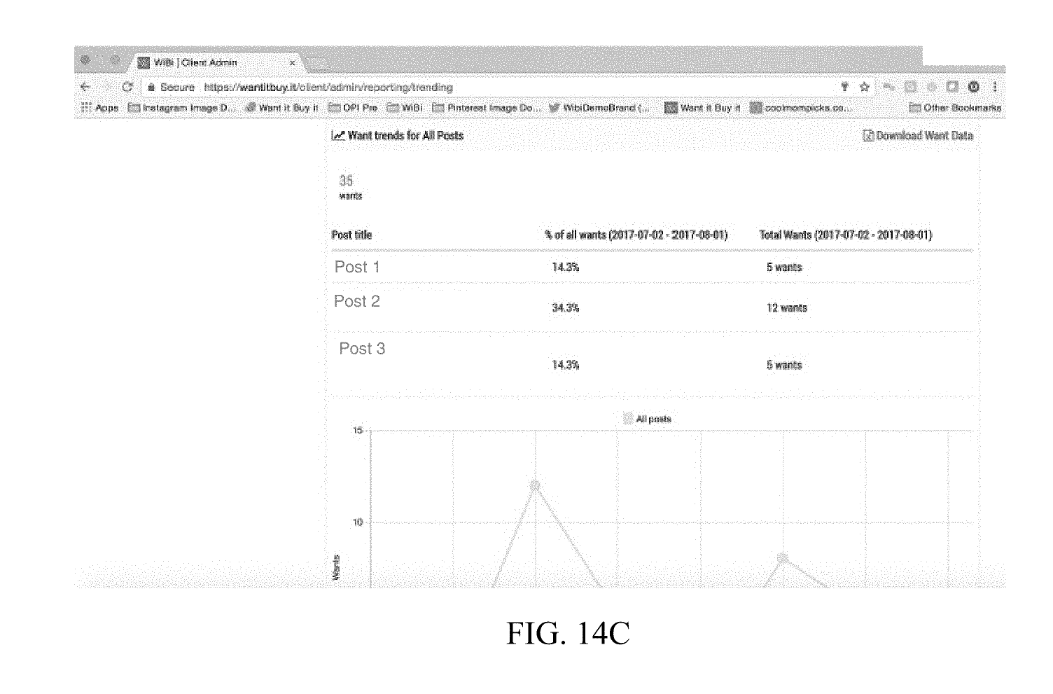

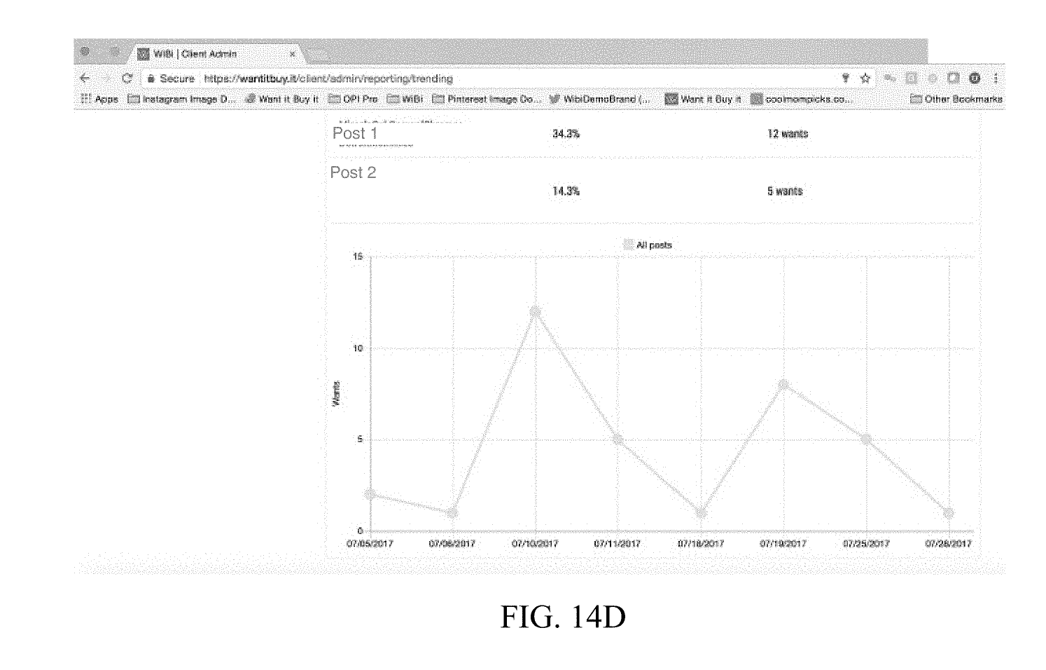

The filters and downloads available when the tab “Shares & Wants” is selected may be the same as those shown in FIG. 13A, so FIGS. 14A-14D include only subsequent screenshots for the post reports and analytics related to shares and wants. The various statistics may be shown by a table, a summary, a graph, or combinations of these display techniques. The statistics related to shares and wants may be broken down by which social media platform was used for the shares, and shares and/or wants per day of one, some, or all posts.

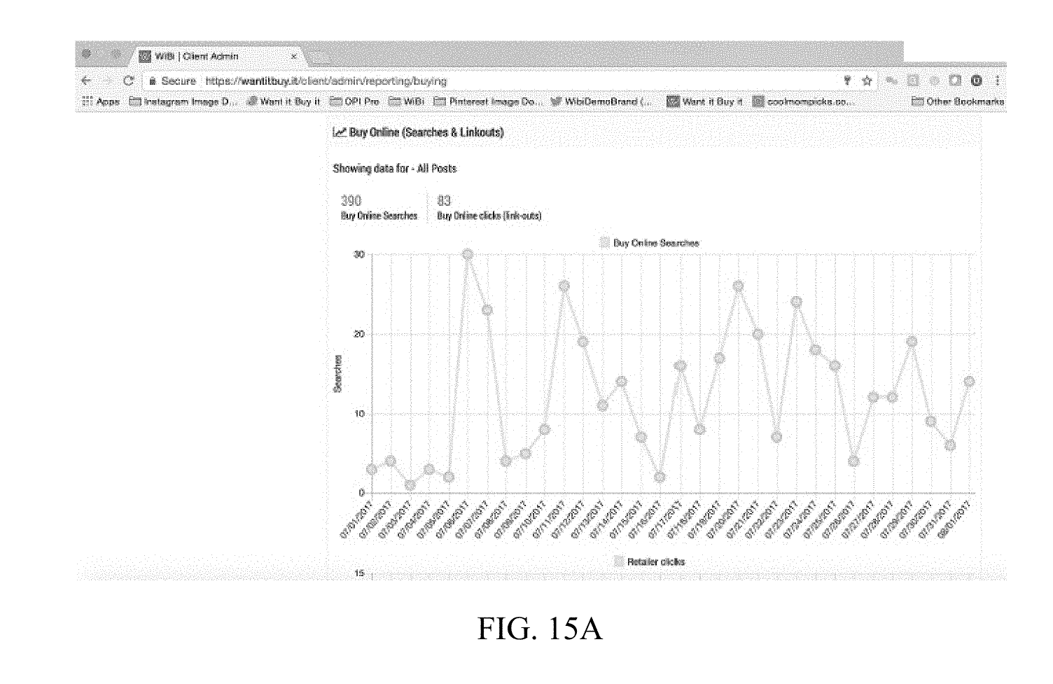

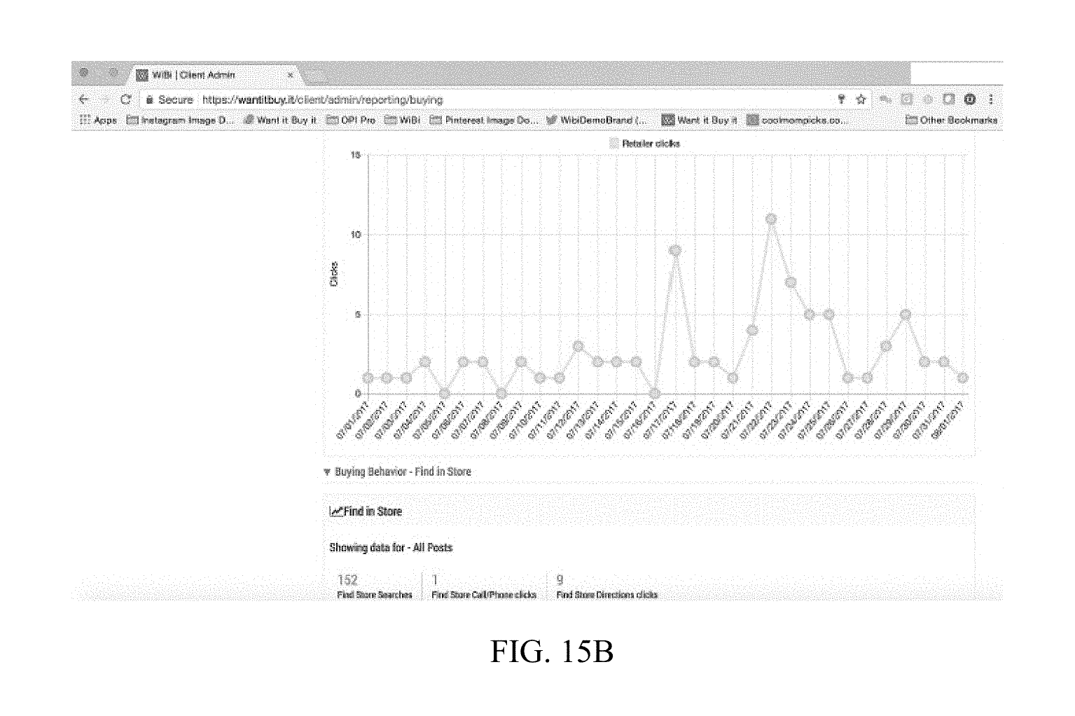

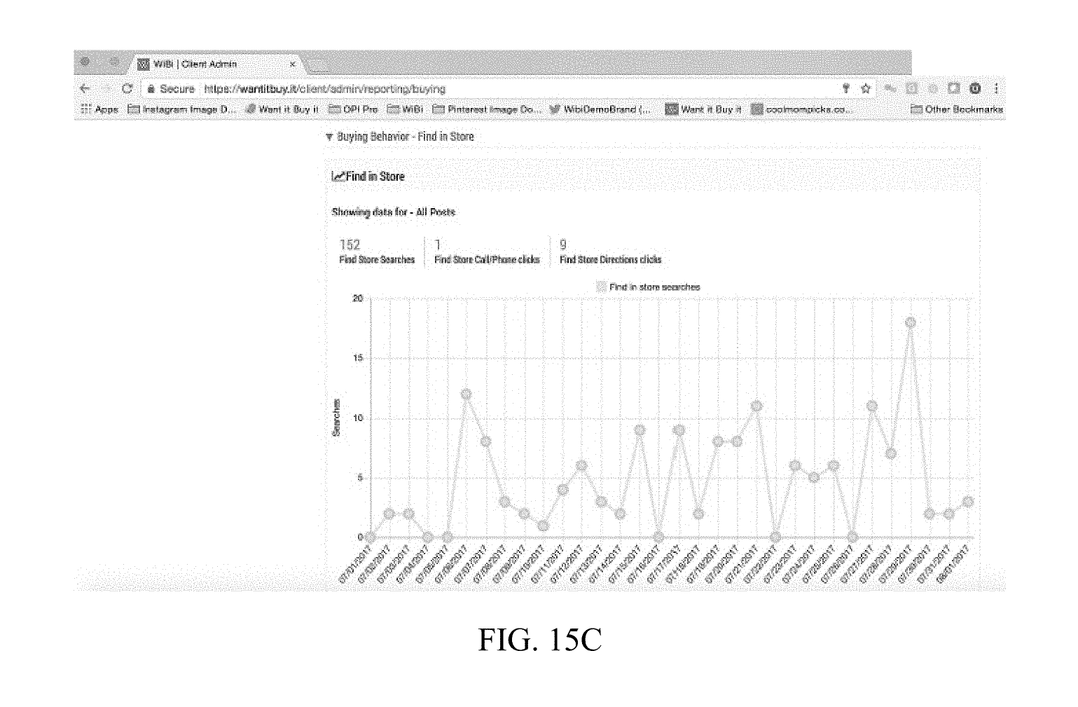

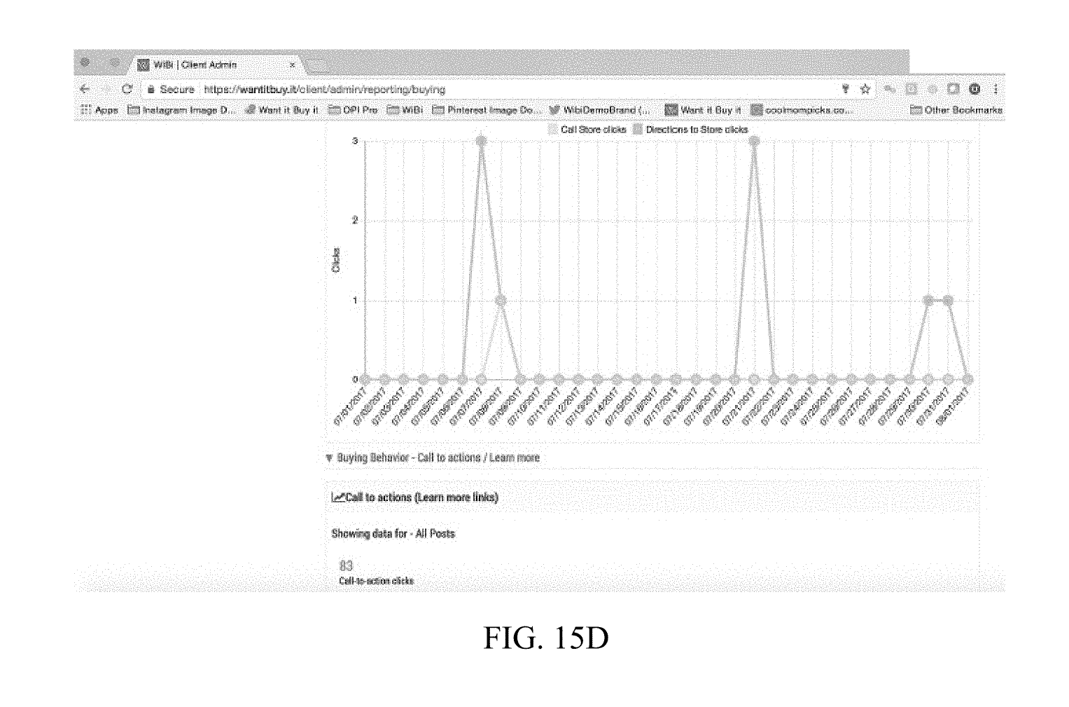

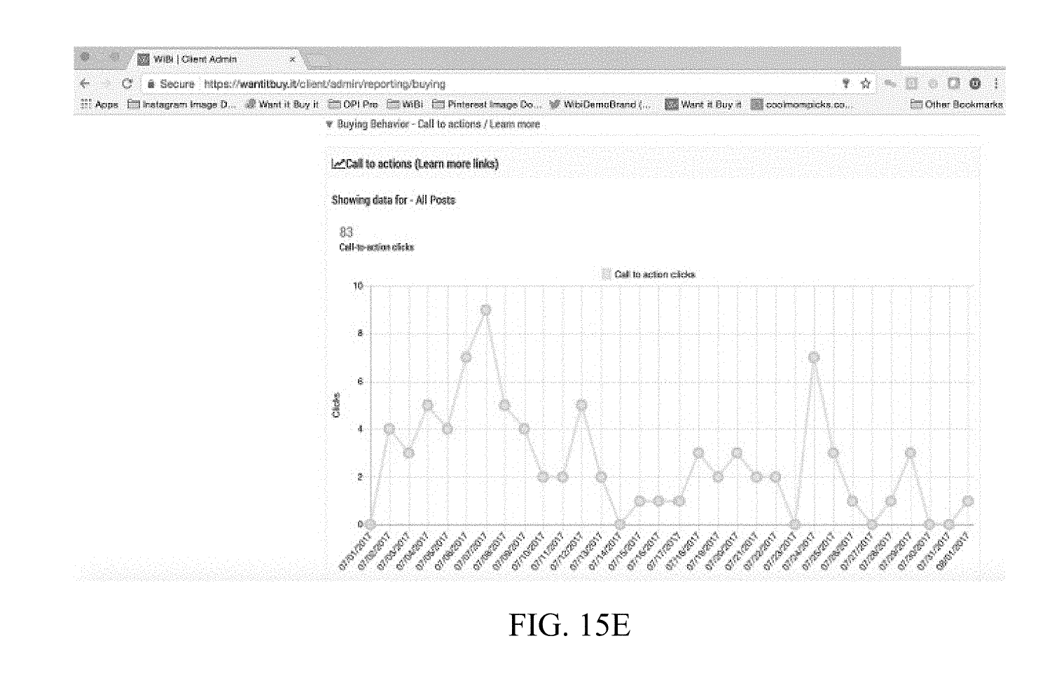

The filters and downloads available when the tab “Buying Behavior” is selected may be the same as those shown in FIG. 13A, so FIGS. 15A-15E include only subsequent screenshots for the post reports and analytics related to buying behavior. The various statistics may be shown by a table, a summary, a graph, or combinations of these display techniques. The statistics related to buying behavior may be broken down by the number of “Buy Online” searches and/or the number of clicks at “Buy Online” linking out to a retailer, the number of “Find Store” searches, clicks of links at a “Phone” entry, and/or clicks of links at a “Directions” entry per day of one, some, or all posts. Further, the number of clicks on links for call to actions may be included, such as a total for a time period and on a per day basis. Although not expressly shown in FIGS. 11A-11D, it is possible for the data acquisition system to prompt the consumer to confirm whether a link to a retail source resulted in a sale. In another implementation, it is possible to use dedicated links to the retail sources such that use of the consumer of the link allows the data acquisition system to directly determine whether or not a click resulted in a sale at a retail source. In either case, a new metric may be included that indicates when a user linking out results in a purchase.

FIGS. 13A-15E represent only some examples of the types of data that may be collected and used in reporting, and the format of that reporting. There are various alternatives available.

The teachings herein describe a solution to technical issues that interfere with the path to purchasing branded items. The solution is data driven, as it provides information along the path to purchase regarding behavior of a consumer. It can also provide fair and equitable treatment to retail sources of the branded items. The solution is channel agnostic in that the same shoppable address can be used on any social, digital, influencer, or print media with metrics analyzed at a central location. Further, it provides a seamless customer solution that allows a consumer to purchase branded items where, when, and how they wish.

As used herein, information, signals, or data are received by transmission or accessing the information, signals, or data in any form, such as receiving by transmission over a network, receiving by accessing from a storage device, or receiving by user operation of an input device.

The foregoing description describes only some exemplary implementations of the described techniques. Other implementations are available. For example, the particular naming of the components, capitalization of terms, the attributes, data structures, or any other programming or structural aspect is not mandatory or significant, and the mechanisms that implement the systems and methods described herein or their features may have different names, formats, or protocols. Also, the particular division of functionality between the various system components described herein is merely exemplary, and not mandatory; functions performed by a single system component may instead be performed by multiple components, and functions performed by multiple components may instead be performed by a single component.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or” unless otherwise specified or clear from context. The articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The implementations of the computer devices (e.g., clients and servers) described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. Further, portions of each of the clients and each of the servers described herein do not necessarily have to be implemented in the same manner.

Operations that are described as being performed by a single processor, computer, or device can be distributed across a number of different processors, computers or devices. Similarly, operations that are described as being performed by different processors, computers, or devices can, in some cases, be performed by a single processor, computer or device.

Although features may be described above or claimed as acting in certain combinations, one or more features of a combination can in some cases be excised from the combination, and the combination may be directed to a sub-combination or variation of a sub-combination.

Some portions of above description include disclosure presented in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations by functional names, without loss of generality. It should be noted that the process/method steps and instructions of implementations of this disclosure could be embodied in software, firmware or hardware, and when embodied in software, could be downloaded to reside on and be operated from different platforms used by real time network operating systems.

Unless specifically stated otherwise as apparent from the above discussion, it is appreciated that throughout the description, discussions utilizing terms such as “processing” or “generating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

All or a portion of the embodiments of the disclosure can take the form of a computer program product accessible from, for example, a non-transitory computer-usable or computer-readable medium. The computer program, when executed, can carry out any of the respective techniques, algorithms and/or instructions described herein. A non-transitory computer-usable or computer-readable medium can be any device that can, for example, tangibly contain, store, communicate, or transport the program for use by or in connection with any processor.

It is to be understood that the disclosure is not to be limited to the disclosed embodiments but, on the contrary, is intended to cover various modifications and equivalent arrangements included within the scope of the appended claims.

What is claimed is:

1. A method for enhancing data acquisition within a computing network, the method comprising:
determining, at a first computing device within the computing network, an image file or a video file for a post related to a first branded item;
determining, at the first computing device, a title for the post;
determining, at the first computing device, multiple retail sources for purchasing the first branded item;
determining, by the first computing device, a shoppable address within the computing network using the title; and
generating, by the first computing device and responsive to selecting the shoppable address included in association with content related to the first branded item within a webpage, the post in the form of a scripted webpage of a website operated by the first computing device, the scripted webpage including a respective link to retail sources of the multiple retail sources.

2. The method of claim 1, wherein the multiple retail sources comprise an on-line retail source and a brick-and-mortar retail source, and the link to the on-line retail source comprises a hyperlink directly to the first branded item within a website of the on-line retail source, and the link to the brick-and-mortar retail source comprises a hyperlink to contact information for the brick-and-mortar retail source within a geographic area defined by the consumer.

3. The method of claim 1, wherein the content related to the first branded item is the image file or the video file for the post, and the webpage is associated with a third-party website operated by other than the first computing device.

4. The method of claim 3, wherein the third-party website comprises a social media platform.

5. The method of claim 1, wherein the content related to the branded item is the image file or the video file for the post, and the webpage is scripted by the first computing device and is populated with content regarding branded items, including the first branded item, from a third-party website operated by other than the first computing device.

6. The method of claim 1, wherein the scripted webpage further comprises, for at least some of the multiple retail sources, purchase information for the first branded item.

7. The method of claim 1, further comprising:
generating a selector for saving the post related to the first branded item to a list unique to the user; and
responsive to the user activating the selector, providing contact data of the user to a brand that is a source of the first branded item.

8. The method of claim 7, wherein the contact data comprises:
an email address of the user;
demographic information; and
path data of the user to the source of the first branded item, the path data indicating an origination of contact of the user with the content regarding the first branded item from within the computing network.

9. The method of claim 1, further comprising:
generating key performance indicators for each of a plurality of platforms including the shoppable address, the key performance indicators including at least one of a click of the shoppable address or a retail conversion to one of the multiple retail sources.

10. The method of claim 1, further comprising:
associating an influencer with the post;
measuring selection of the shoppable address embedded in a website of the influencer; and
measuring selection, by users originating from the website of the influencer, of the links of the multiple retail sources within the scripted webpage.

11. The method of claim 1, wherein determining the multiple retail sources comprises:
receiving selection of a set of retail sources from a user;
searching the computing network for references to the first branded item using a unique product identifier; and
filtering results of the search by the set of retail sources, wherein the multiple retail sources comprise at least some of the set of retail sources referring to the first branded item.

12. The method of claim 1, wherein the image file or the video file includes an image of the first branded item, the method further comprising:
identifying a second branded item included within the image file or the video file; and
determining at least one retail source for purchasing the second branded item, wherein the scripted webpage includes a respective link to the at least one retail source.

13. The method of claim 12, wherein identifying the second branded item comprises tagging the second branded item within the image file or the video file, the method further comprising:
tagging the first branded item within the image file or the video file.

14. The method of claim 1, further comprising:
generating a plurality of posts for the website operated by the first computing device, each post related to at least one branded item and associated with a unique webpage address within the website; and
storing at least some of the plurality of posts according to a time limit defined by a user

15. The method of claim 14, wherein at least one of the plurality of posts is related to a branded item that is not available for retail purchase.

16. A system for enhancing data acquisition within a computing network, the apparatus comprising:
a non-transitory storage medium; and
a processor of a first computing device within the computing network configured to execute instructions stored within the non-transitory storage medium to perform a method comprising:
determining an image file or a video file for a post related to a first branded item;
determining a title for the post;
determining multiple retail sources for purchasing the first branded item;
determining a shoppable address within the computing network using the title; and
generating, responsive to selecting the shoppable address included in association with content related to the branded item within a webpage, the post in the form of a scripted webpage of a website operated by the first computing device, the scripted webpage including a respective link to retail sources of the multiple retail sources.

17. The apparatus of claim 16, wherein the scripted webpage includes a call of action comprising at least one of:
purchasing the first branded item on-line;
finding a local retail source of the multiple retail sources;
sharing the shoppable address with a third party;
accessing a link to learn more regarding the first branded item; or
saving information related to the first branded item.

18. The apparatus of claim 16, wherein the post has only one of the image file or the video file.

19. The apparatus of claim 16, wherein the post is one of a plurality of posts, the method further comprising:
storing a list of the plurality of posts according to a number of users selecting a respective shoppable address of the post.

20. The apparatus of claim 16, wherein the scripted webpage further comprises, for at least some of the multiple retail sources, purchase information for the first branded item, the purchase information including a respective price where available and otherwise including a message.
